(19) United States
(12) Patent Application Publication
(10) Pub. No.: US 2026/0094036 A1
(43) Pub. Date: Apr. 2, 2026

(54) Quantum Computer Apparatus and Method for Operation

(71) Applicant: Quantinuum GmbH, München (DE)

(72) Inventors: Henrik Dreyer, München (DE); Mohsin Iqbal, München (DE)

(73) Assignee: Quantinuum GmbH, München (DE)

(21) Appl. No.: 19/110,997

(22) PCT Filed: Sep. 13, 2023
(86) PCT No.: PCT/EP2023/075187

§ 371 Date: Mar. 12, 2025

(30) Foreign Application Priority Data
Sep. 13, 2022 (GB) 2213373.0

(51) Int. Cl. G06N 10/20; G06N 10/40; G06N 10/60

(52) U.S. Cl. CPC G06N 10/20; G06N 10/40; G06N 10/60

(57) ABSTRACT

There is provided a hybrid computing arrangement this is configured to implement a simulation of a chemical system, wherein the hybrid computing arrangement includes a combination of a classical computer coupled to a quantum computer, wherein the hybrid computing arrangement is configured in use to receive input data and to generate corresponding processed output data from the input data, wherein the computing arrangement is: (a) configured to receive information describing a chemical system in the input data: (b) configured to process the information describing the chemical system using a pre-entangler algorithm and a fixed circuit algorithm to generate a quantum ansatz defining initial values for a quantum circuit computation, and a Hamiltonian from which is generated a variational circuit algorithm: (c) configured to compute using the quantum ansatz and the variation circuit algorithm a corresponding quantum circuit to generate quantum computations results; and (d) configured to process the quantum computational results to generate the output data including information describing an electron orbital simulation of the chemical system.

### TECHNICAL FIELD

The present disclosure relates to a quantum computer apparatus, for example to a hybrid computer apparatus including a combination of a classical binary computer coupled to a quantum computer. Moreover, the present disclosure relates to a method for operating the quantum computer apparatus. Furthermore, the present disclosure relates to software products recorded on machine-readable media, wherein the software products when executable on the aforesaid quantum computer apparatus to implement the aforesaid methods.

### BACKGROUND

Quantum computers have recently become available [1] as noisy intermediate scale quantum (NISQ) devices; moreover, quantum computers are classically susceptible to being simulated (namely “emulated”). A technical problem associated with NISQ devices is that their currently available qubits are too noisy to run deep quantum circuits as required for most rewarding applications of quantum computers; for example, phase estimation for qubits is challenging to implement on NISQ devices. To bridge a gap between contemporary NISQ devices and future fault-tolerant quantum computer apparatus, many researchers have turned to using variational quantum algorithms such as variational quantum eigensolvers (VQE), quantum optimization algorithms, variational imaginary time evolution algorithms, variational quantum adiabatic algorithms and quantum neural network algorithms [2-8]. Variational quantum circuits that are executable using NISQ devices are typically shallower than many other types of quantum circuits executed using such devices; on account of such shallowness, the variational quantum circuits beneficially exhibit certain algorithmic resilience against noise. Moreover, such variational quantum circuits function iteratively by evaluating a given objective function of a given optimization problem on a given NISQ device, and update variational parameters of the variational quantum circuits by using a classical optimization algorithm.

Unfortunately, devising quantum circuit ansatzes that are sufficiently expressive suffer from gradients that vanish exponentially as a function of the number of qubits used, resulting in barren plateaus that take an exponential time to exit [9]. In the presence of noise, even less expressive, problem-inspired ansatzes suffer from barren plateaus, as long as a superlinear number of parameterized gates is to be trained [10]. Reducing the number of variational parameters is therefore critical for the success of near-term variational quantum algorithms. Vanishing gradients had also posed an early challenge to deep neural networks in classical machine learning.

In overview, from classical canonical transformation theory, molecular electronic correlations are typically divided into two components. Static correlation has been used to quantify a part of electronic correlation that is associated with multiple relevant determinants close in energy to the Highest Occupied Molecular Orbital (HOMO) and Lowest Un-occupied Molecular Orbital (LUMO). Dynamical correlation describes corrections to ground states arising from excitations involving low-lying core orbitals or high-lying virtual orbitals. When static correlation is negligible, this is referred as being single-reference chemistry. In such a situation, classical coupled cluster (CC) methods are generally sufficient to describe dynamical correlation wells, if done with sufficiently large basis sets [19]. Conversely, a multi-reference situation occurs when a single determinant is not sufficient to describe chemical bonding, not even qualitatively. In practice, these situations are found in chemical reactions, namely where valence configurations of products and reactants pass points of almost vanishing HOMO-LUMO gap, excited states and transition metal chemistry [20].

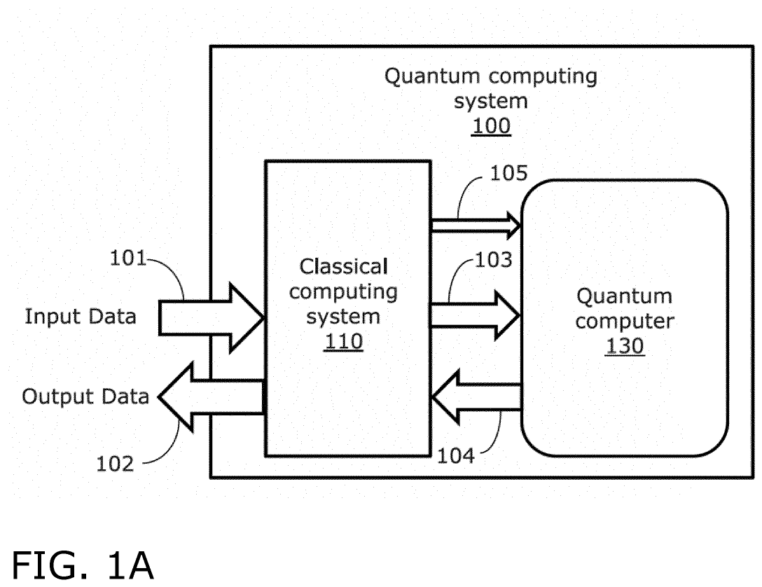

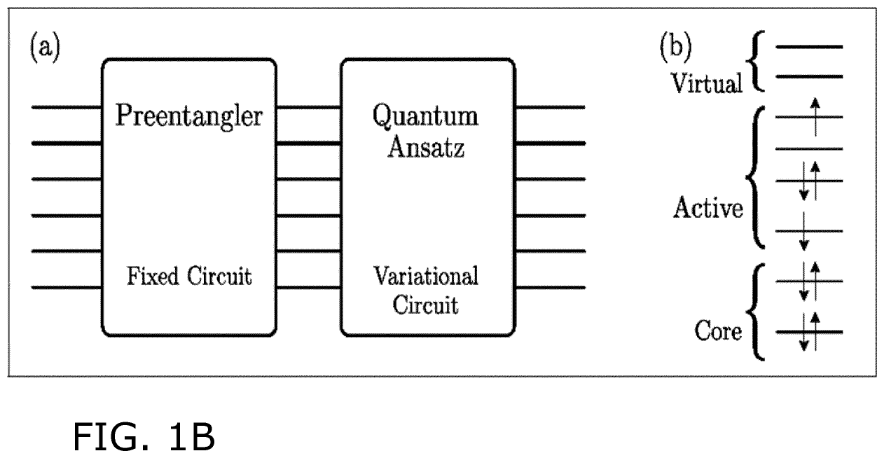

To tackle multi-reference settings, when implementing quantum chemistry simulations, it is a conventional approach usually to split the molecular orbitals into core (c), active (a) and virtual (v) orbitals as illustrated in FIG. 1b, wherein:
(i) the core orbitals are defined to be completely filled,
(ii) orbitals in the active space are partially filled, and
(iii) the orbitals in the virtual space are empty.

An optimal way to assign an active space is unknown and initially relies on chemical intuition. Modern computer software programs such as BLOCK [21] and AutoCAS (22-25] use a Fiedler vector as a proxy for mutual information between orbitals, as well as machine learning algorithms to automate assignment of the active space. The Hilbert space is then partitioned as [symbol] = [symbol] _{c}⊗ [symbol] ₐ⊗ [symbol] ᵥ; throughout the present disclosure, it is assumed a Jordan-Wigner mapping from fermionic Fock space to qubits under which Slater determinants map to product states and |1 [symbol] (|0 [symbol] ) denotes occupied (unoccupied) orbitals.

To tackle multi-reference settings, many methods have been developed, for example multi-reference coupled clusters [26], all of which are computationally expensive when executed using a NISQ device. In the following, Canonical Transformation Theory (CT Theory) will be further elucidated to assist understanding of the subject matter of the present disclosure. The present disclosure uses a CAS-DMRG ansatz to define initial values of qubits used when executing a quantum circuit on a NISQ device. In CT Theory, for a given qubit, an initial value is given by Equations (1) and (2):

$${{{\vert {ψ}_{0} 〉 = \vert 1 〉}_{c} ⊗ \vert MPS 〉}_{a} ⊗ \vert 0 〉}_{υ} , \qquad ( 1 )$$

$$where$$

$${\vert MPS 〉}_{a} = {\sum }_{\begin{matrix}{i}_{1} … {i}_{M} \\ {α}_{1} … {α}_{M - 1}\end{matrix}} {A}_{{α}_{1} , {i}_{1}}^{[ 1 ]} {A}_{{α}_{1} {α}_{2} , {i}_{2}}^{[ 2 ]} … {A}_{{α}_{M - 1 , {i}_{M}}}^{[ M ]} \vert {i}_{1} … {i}_{M} 〉 . \qquad ( 2 )$$

Here, M is the number of spin orbitals in the active space, physical indices iⱼ run from 0 to 1 and αⱼ takes values in a range 1 . . . Dⱼ, wherein Dⱼ is the bond dimension of bond j. The bond dimension D of the MPS is defined as being a maximum over all Dⱼ. Objects A^{[j]} are matrices for j∈{1, M} and three-legged tensors in a given bulk. The cost of the optimisation scales as [symbol] (MD³) and computations up to D=1000 can be carried out routinely, while the largest reported bond dimension on a supercomputer chemistry simulation is D=65536 [27]. In practice, much lower bond dimensions can yield accurate results, in particular for quasi one-dimensional geometries, where convergence has been achieved for active spaces of up to 100 orbitals [28, 29].

A major challenge of CAS-DMRG is to recover dynamic correlations. Single-reference CC methods are applicable since a given excitation operator assumes a fixed orbital occupancy of a given reference state. One proposal to overcome this problem is Canonical Transformation (CT) Theory [14, 30-33], as aforementioned. In CT, the CC excitation operator is replaced by a unitary operator is provided in Equation (3):

$$U = {e}^{T} , \qquad ( 3 )$$

$$wherein$$

$$\begin{matrix}T & = & {θ}_{{c}_{1}}^{{a}_{1}} {τ}_{{c}_{1}}^{{a}_{1}} + {θ}_{{c}_{1} {c}_{2}}^{{a}_{1} {a}_{2}} {τ}_{{c}_{1} {c}_{2}}^{{a}_{1} {a}_{2}} + {θ}_{{a}_{3} {c}_{1}}^{{a}_{1} {a}_{2}} {τ}_{{a}_{3} {c}_{1}}^{{a}_{1} {a}_{2}} & ( core - active ) \\ & + & {θ}_{{a}_{1}}^{{υ}_{1}} {τ}_{{a}_{1}}^{υ1} + {θ}_{{a}_{1} {a}_{2}}^{{υ}_{1} {υ}_{2}} {τ}_{{a}_{1} {a}_{2}}^{{υ}_{1} υ2} + {θ}_{{a}_{1} {a}_{2}}^{{a}_{3} {υ}_{1}} {τ}_{{a}_{1} {a}_{2}}^{{a}_{3} {υ}_{1}} & ( active - virtual ) \\ & + & {θ}_{{a}_{1} {c}_{1}}^{{a}_{2} {υ}_{1}} {τ}_{{a}_{1} {c}_{1}}^{{a}_{2} {υ}_{1}} + {θ}_{{a}_{1} {c}_{1}}^{{υ}_{1} {υ}_{2}} {τ}_{{a}_{1} {c}_{1}}^{{υ}_{1} {υ}_{2}} + {θ}_{{c}_{1} {c}_{2}}^{{a}_{1} {υ}_{1}} {τ}_{{c}_{1} {c}_{2}}^{{a}_{1} {υ}_{1}} & ( core - active - virtual ) \\ & + & {θ}_{{c}_{1}}^{{υ}_{1}} {τ}_{{c}_{1}}^{{υ}_{1}} + {θ}_{{c}_{1} {c}_{2}}^{{υ}_{1} {υ}_{2}} {τ}_{{c}_{1} {c}_{2}}^{{υ}_{1} {υ}_{2}} . & ( core - virtual )\end{matrix}$$

$${τ}_{i}^{a} = {a}_{i}^{†} {a}_{a} - {a}_{a}^{†} {a}_{i} , and {τ}_{ij}^{ab} = {a}_{a}^{†} {a}_{b}^{†} {a}_{i} {a}_{j} - {a}_{i}^{†} {a}_{j}^{†} {a}_{a} {a}_{b} .$$

Indices labeled as c_{•}, a_{•}, and v_{•} correspond to orbitals in the core, active, and virtual spaces respectively and the repeated indices in each term are assumed to be summed over.
The unitary U is then applied to the reference state as provided in Equation (4):

$$\vert ψ 〉 = U \vert {ψ}_{0} 〉 . \qquad ( 4 )$$

Coefficients θ need to be optimized. Classically, this optimization proceeds as follows: the exponential can be expanded as provided in Equation (5):

$$\begin{matrix}E = 〈 {ψ}_{0} \vert {e}^{- T} H {e}^{T} \vert {ψ}_{0} 〉 \\ = 〈 {ψ}_{0} \vert H + [ H , T ] + \frac{1}{2} [ [ H , T ] , T ] + … \vert {ψ}_{0} 〉 .\end{matrix} \qquad ( 5 )$$

On a classical binary computer, an exact and efficient implementation of Equation (5) is not possible. Such impossibility is because expressions like [[H,T],T] contain N-point correlation functions and, while 1-body and 2-body reduced density matrices of the reference wavefunction can be computed, the computation of general N-body terms will necessarily take exponential time. In CT theory, higher-order terms are therefore approximated by sums of products of one- and two-body terms using the so-called cumulant expansion [34]. The convergence of the cumulant expansion is generally fast in single-reference scenarios but slow for multi-reference systems. Ironically, these are precisely the systems that CAS-DMRG is particularly suited for [35]. Thus, to remove the main limitation of CT Theory, alternative methods to compute (5) must be found.

### SUMMARY OF THE DISCLOSURE

An aim of the present disclosure is to provide an improved method for configuring a quantum computer apparatus to implement quantum chemistry simulations; such simulations are susceptible to being used in processes for manufacturing chemical materials, pharmaceutical product and for designing and controlling chemical production machinery.

According to first aspect, there is provided a method for configuring a hybrid computing arrangement to implement a simulation of a chemical system, wherein the hybrid computing arrangement includes a combination of a classical computer coupled to a quantum computer, wherein the hybrid computing arrangement is configured in use to receive input data and to generate corresponding processed output data from the input data, wherein the method includes:
(a) configuring the classical computer to receive information describing a chemical system in the input data;
(b) configuring the classical computer to process the information describing the chemical system using a pre-entangler algorithm and a fixed circuit algorithm to generate a quantum ansatz defining initial values for a quantum circuit computation, and a Hamiltonian from which is generated a variational circuit algorithm;
(c) configuring the quantum computer to compute, using the quantum ansatz and the variational circuit algorithm, a corresponding quantum circuit to generate quantum computations results; and
(d) configuring the classical computer to process the quantum computational results to generate the output data including information describing an electron orbital simulation of the chemical system.

The invention is of advantage in that using pre-entanglers, for example parameter-free pre-entanglers, allows the computational burden to be shifted from the quantum computer to the classical computer. Moreover, the invention is of advantage in that number of parameters in the variational quantum circuit algorithm can be reduced, especially as the number of qubits used in the quantum circuit is increased.

Optionally, the method includes configuring the pre-entangler algorithm to function as a parameter-free pre-entangler. More optionally, the method includes configuring the pre-entangler algorithm using a Matrix Product States (MPS) algorithm. More optionally, the method includes generating Matrix Product States (MPS) based on a linear combination of unitaries describing the chemical system. Optionally, the method includes configuring the hybrid computer arrangement to generate Matrix Product States (MPS) using a Density Matrix Renormalization Group (DMRG) algorithm, to capture a complete active space (CAS) for one or more non-linear transition metal complexes included in the chemical system. Optionally, the method includes configuring the hybrid computer arrangement to generate Matrix Product States (MPS) by using the MPS algorithms based on a sequential generation with ancilla.

Optionally, the method includes using the quantum circuit to find ground states of the Hamiltonian.

Optionally, the method includes configuring the variational quantum circuit algorithm as a variational quantum eigensolver based on one or more Canonical Transformations, wherein the method includes configuring the hybrid computing arrangement to use the classical computer to generate a Density Matrix Renormalization Group (DMRG) algorithm to build static correlations in wavefunctions describing the chemical system, wherein the Density Matrix Renormalization Group (DMRG) algorithm is used to generate a corresponding DMRG-QCT part of the quantum circuit.

Optionally, the method includes configuring the hybrid computing arrangement:
(i) to assign molecular orbits to an active space based on the molecular system; wherein the orbits are susceptible to occupying core, virtual and active spaces;
(ii) to use an algorithm to approximate ground states of the Hamiltonian by using a MSRG algorithm to generate a Matrix Product States (MPS) description |ψ₀ [symbol] of a ground state for a given bond dimension D;
(iii) to find a quantum circuit that prepares the MPS description |ψ₀ [symbol] on the quantum computer;
(iv) to construct a variational quantum circuit to describe dynamic correlations by coupling active orbitals in the core and active spaces; and
(v) from results of executing the quantum circuit to minimize ground state energies to generate the output results.

According to a second aspect, there is provided a hybrid computing arrangement this is configured to implement a simulation of a chemical system, wherein the hybrid computing arrangement includes a combination of a classical computer coupled to a quantum computer, wherein the hybrid computing arrangement is configured in use to receive input data and to generate corresponding processed output data from the input data, wherein the computing arrangement is:
(a) configured to receive information describing a chemical system in the input data;
(b) configured to process the information describing the chemical system using a pre-entangler algorithm and a fixed circuit algorithm to generate a quantum ansatz defining initial values for a quantum circuit computation, and a Hamiltonian from which is generated a variational circuit algorithm;
(c) configured to compute using the quantum ansatz and the variational circuit algorithm a corresponding quantum circuit to generate quantum computations results; and
(d) configured to process the quantum computational results to generate the output data including information describing an electron orbital simulation of the chemical system.

Optionally, in the hybrid computing arrangement, the pre-entangler algorithm is configured to function as a parameter-free pre-entangler.

Optionally, in the hybrid computing arrangement, the pre-entangler algorithm is configured to use a Matrix Product States (MPS) algorithm. More optionally, the hybrid computer arrangement is configured to generate Matrix Product States (MPS) using a Density Matrix Renormalization Group (DMRG) algorithm, to capture a complete active space (CAS) for one or more non-linear transition metal complexes included in the chemical system. More optionally, the hybrid computer arrangement is configured to generate Matrix Product States (MPS) by using the MPS algorithms based on a sequential generation with ancilla.

Optionally, the hybrid computing arrangement is configured to use the quantum circuit to find ground states of the Hamiltonian.

Optionally, the hybrid computing arrangement is configured to include the variational quantum circuit algorithm as a variational quantum eigensolver based on one or more Canonical Transformations, wherein the hybrid computing arrangement is configured to use the classical computer to generate a Density Matrix Renormalization Group (DMRG) algorithm to build static correlations in wavefunctions describing the chemical system, wherein the Density Matrix Renormalization Group (DMRG) algorithm is used generate a corresponding DMRG-QCT part of the quantum circuit.

Optionally, the hybrid computing arrangement is configured:
(i) to assign molecular orbits to an active space based on the molecular system; wherein the orbits are susceptible to occupying core, virtual and active spaces;
(ii) to use an algorithm to approximate ground states of the Hamiltonian by using a MSRG algorithm to generate a Matrix Product States (MPS) description |ψ₀ [symbol] of a ground state for a given bond dimension D;
(iii) to find a quantum circuit that prepares the MPS description |ψ₀ [symbol] on the quantum computer;
(iv) to construct a variational quantum circuit to describe dynamic correlations by coupling active orbitals in the core and active spaces; and
(v) from results of executing the quantum circuit to minimize ground state energies to generate the output results.

According to a third aspect, there is provided a non-transitory computer-readable storage medium comprising specific computer-readable instructions executable on data processing hardware, wherein the specific computer-readable instructions, when executed the data processing hardware, implement the method of the first aspect.

Additional aspects, advantages, features and objects of the present disclosure would be made apparent from the drawings and the detailed description of the illustrative embodiments construed in conjunction with the appended claims that follow.

It will be appreciated that features of the present disclosure are susceptible to being combined in various combinations without departing from the scope of the present disclosure as defined by the appended claims.

### DESCRIPTION OF THE DIAGRAMS

Embodiments of the disclosure will be described with reference to the following drawings, wherein:

FIG. 1A is an illustration of a quantum computer apparatus including a classical computing arrangement coupled to a quantum computing arrangement, wherein the classical computing arrangement and the quantum computing arrangement operate in tandem to execute computational tasks involving the generation and execution of quantum circuits;

FIG. 1B is an illustration, wherein (a) is a depiction of a generic structure of a pre-entangled variational quantum algorithm; and (b) is a depiction of a classification of spin orbitals in complete active space methods;

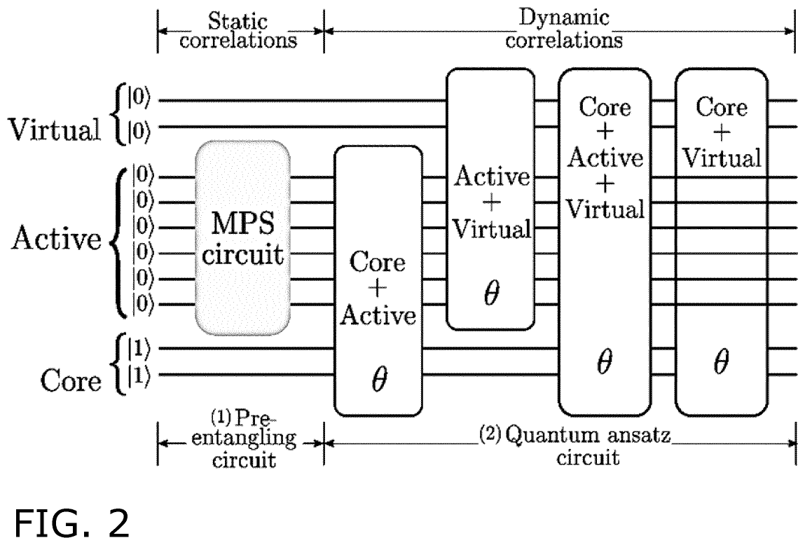

FIG. 2 is an illustration of a quantum circuit for computing DMRG-QCT;

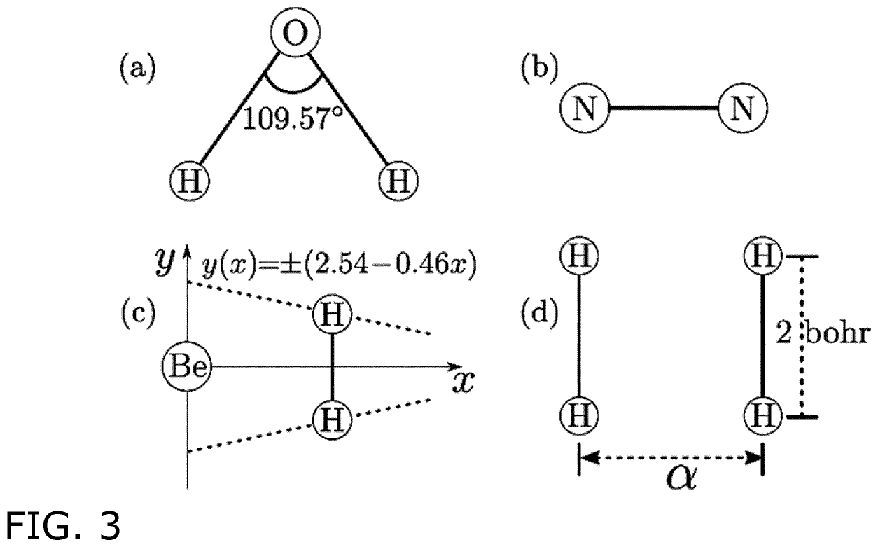

FIG. 3 is an illustration, wherein (a) is a depiction of a water molecule with an equilibrium bond angle, (b) is a depiction of a Nitrogen dimer, (c) is a depiction of a BeH₂ molecule as a sum of a Be atom and an H₂ molecule, and (d) is a depiction of a P4 system including two H₂ molecules;

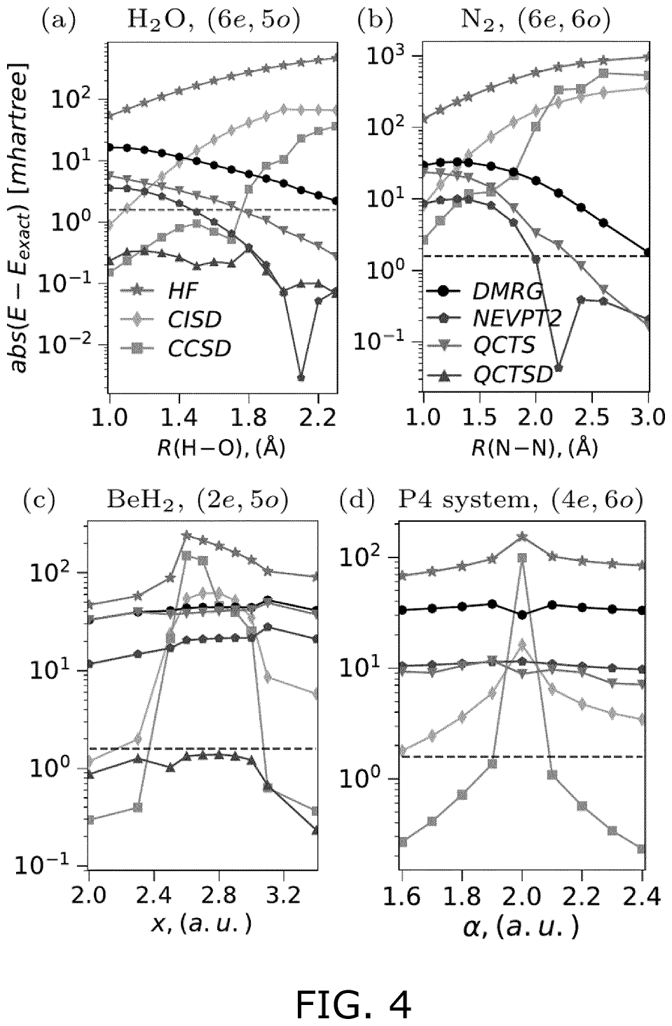

FIG. 4 is an illustration of an absolute energy error of mutually different methods for approximating ground state energies by way of using quantum circuits. The energy error is strictly positive for every method except for CCSD, where it is negative for a few points. In FIG. 4, there is shown: (a) a water molecule in a STO-6G basis set including 14 qubits and an active space used for a DMRG calculation that includes 5×2=10 spin orbitals; (b) a Nitrogen-dimer in STO-6G with an active space of 12 spin-orbitals; (c) BeH₂ in a STO-6G basis set with an active space of 10 spin orbitals; (d) a P4 model system with a 6-31G basis set and an active space including 12 spin orbitals. All plots illustrated in FIG. 4 share a same common legend that is shown in a divided manner in (a) and (b);

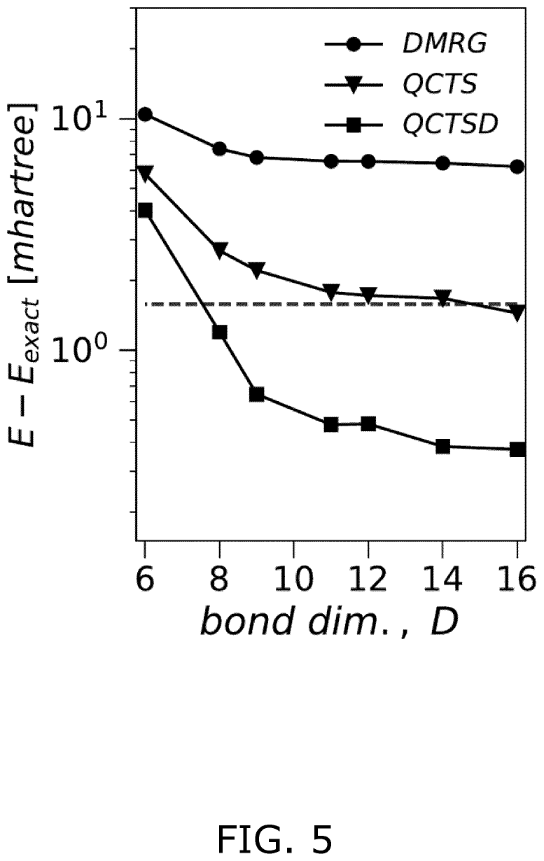

FIG. 5 is an illustration of an energy error as a function of a bond dimension D used in a DMRG used for the water molecule at R(O—H)=108 Angstroms, wherein D=16 is the bond dimension for the exact active (namely, without any approximation) as used in FIG. 4;

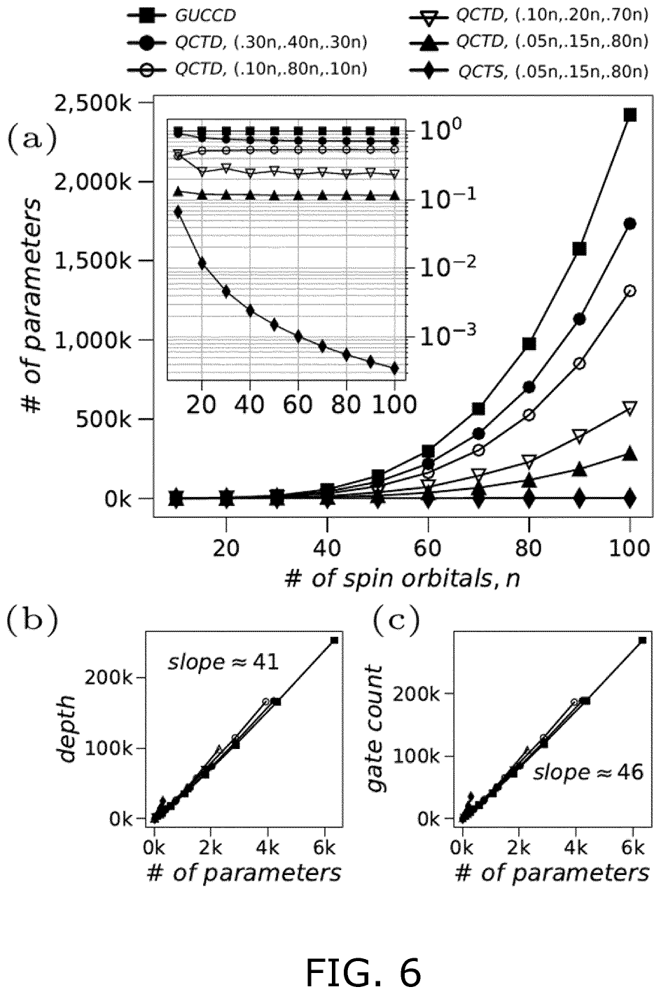

FIG. 6 is an illustration of: (a) the growth in the number of parameters for GUCC and DMRG-QCT ansatzes, wherein there is shown an inset that presents a same given data, but normalized by the number of parameters in the GUCC ansatz; and (b) and (c) a depiction of a scaling of a quantum circuit depth and a number of quantum gates required as a function of a variational parameters count;

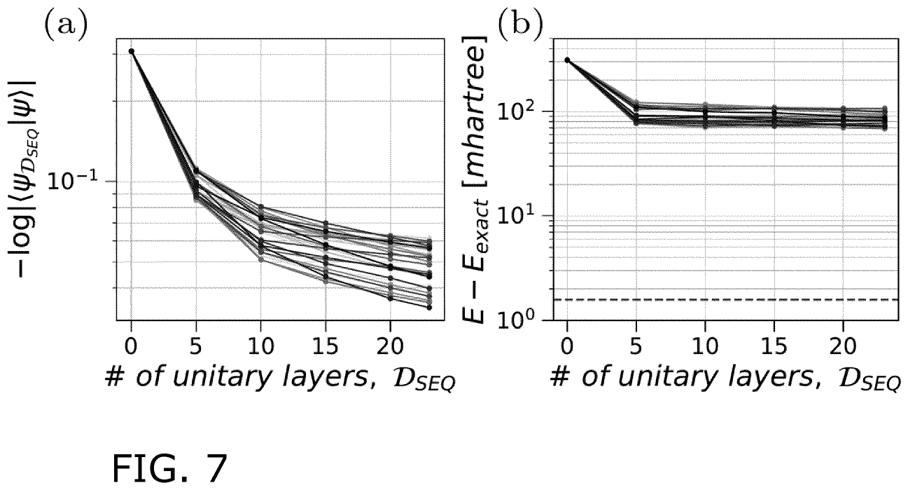

FIG. 7 is an illustration of: (a) a fidelity of approximate states prepared by an SEQ algorithm with respect to a ground state of a N₂ molecule in a STO-6G basis set with 20 qubits, wherein the atomic distance N−N=1.8 Angstroms; (b) an energy error for the same molecule, wherein there is shown a grey region that depicts an error below the chemical accuracy;

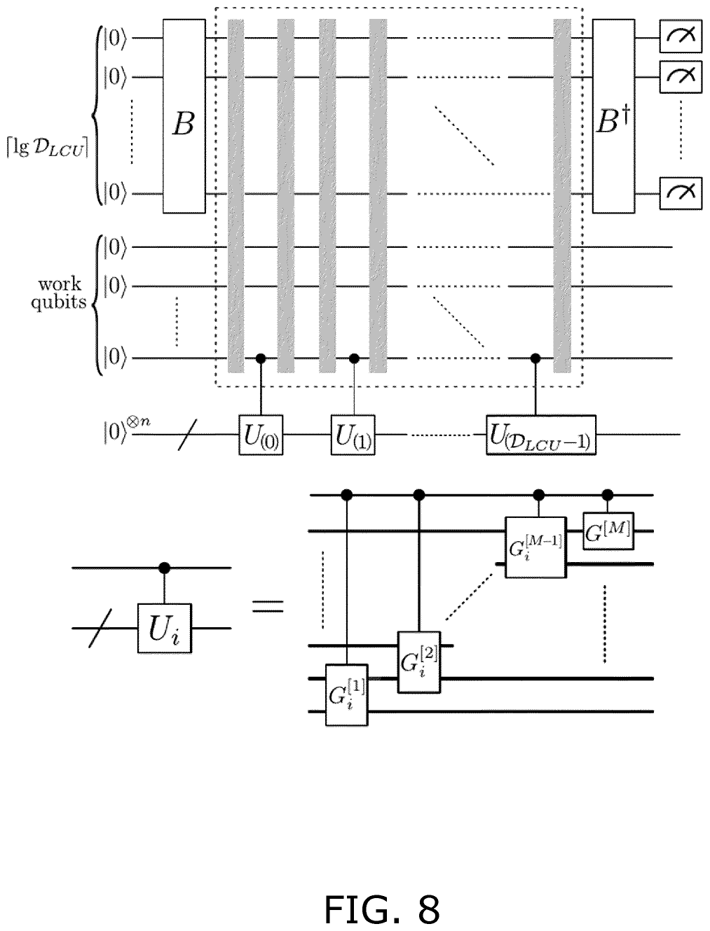

FIG. 8 is an illustration of (i) (top) a non-deterministic circuit for constructing a linear combination of unitaries; (ii) (bottom) a multi-qubit controlled unitary described in terms of one- and two-body gates;

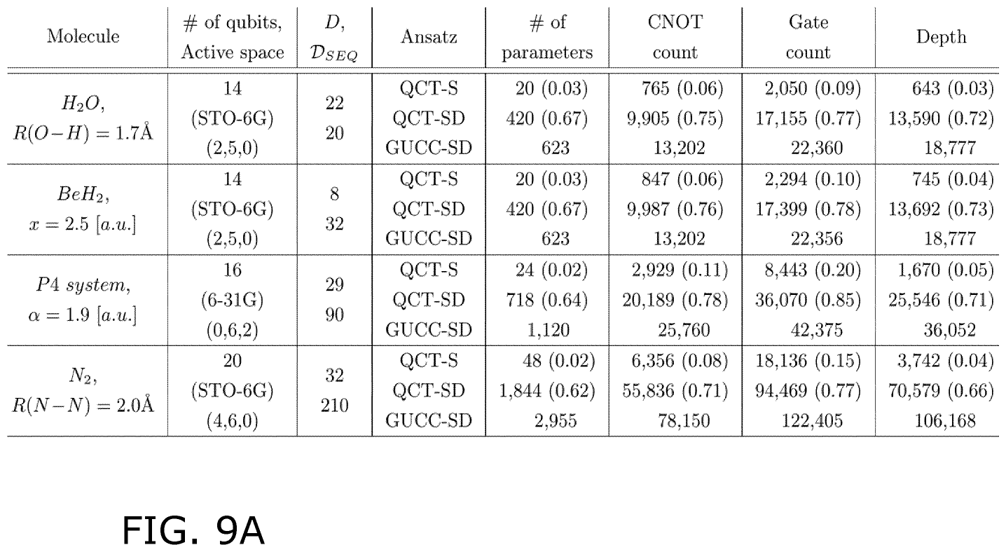

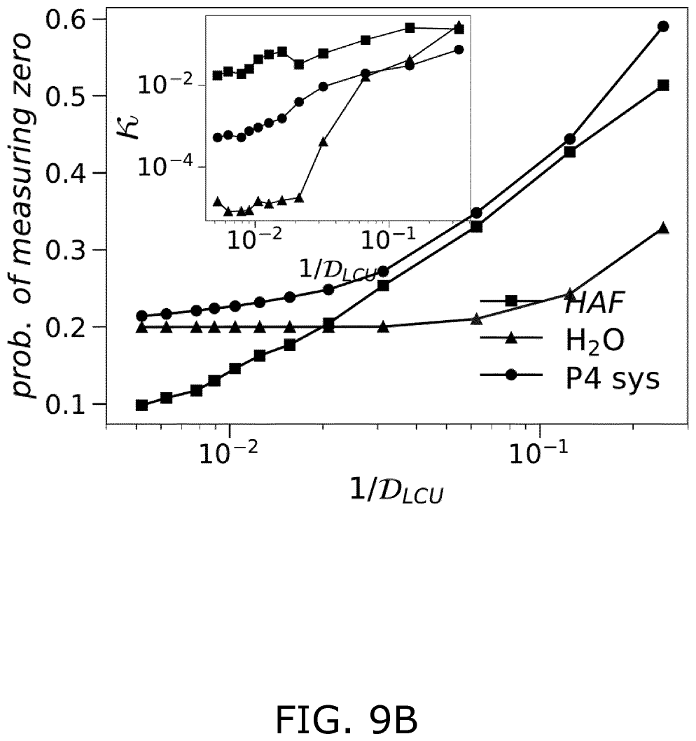

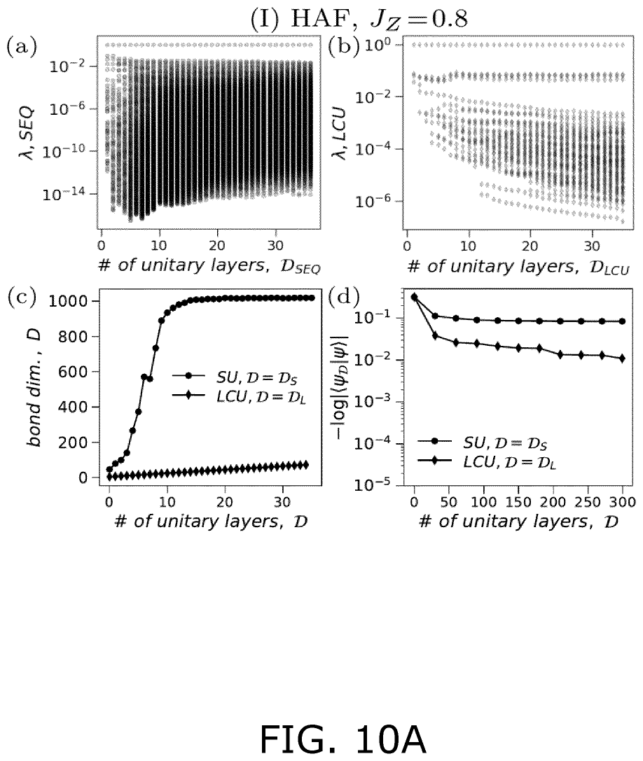

FIG. 9A is a table of circuit requirements for molecules considered for molecules described in the present disclosure. In the table, (•) denotes requirements of QCT-S and QCT-SD normalized with respect to GUCC-SD. In the third column, there is included a bond dimension D of the MPS from DMRG, and the number of layers [symbol] _{SEQ} employed by the sequential unitary algorithm to approximate the MPS with a given desired accuracy;

FIG. 9B is a depiction of a probability of measuring zero for a LCU circuit as illustrated in FIG. 8. There is shown inset data for convergence of κ's as a function of 1/ [symbol] _{LCU}. HAF labels data for the ground state of a Heisenberg Antiferromagnet (HAF) chain, H=Σ(XᵢXᵢ₊₁+YᵢYᵢ₊₁+J_{Z}ZᵢZᵢ₊₁) with 16 sites. H₂O denotes data for a water molecule as illustrated in FIG. 3(a) in STO-6G basis set with 14 qubits. Moreover, P4 sys labels results for the ground state of the P4 model system as shown in FIG. 3(c) in STO-6G basis set with 16 qubits are also depicted;

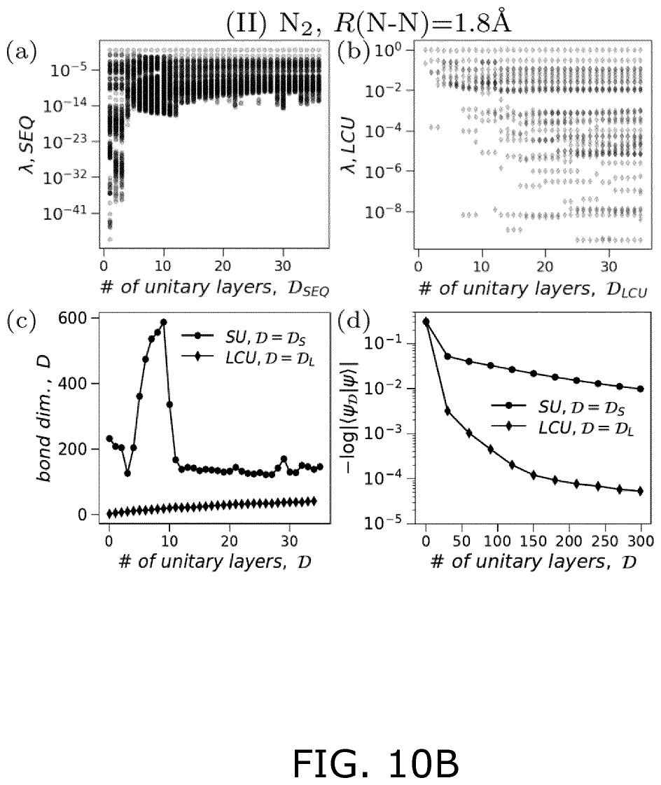

FIG. 10A (I) depicts results for the ground state of HAF with 20 spins, and FIG. 10B (II) depicts data for the N₂ molecule. Moreover, (a, b) denotes Schmidt values for the two algorithms without any truncation of Dₘₐₓ. Furthermore, in (c) the bond dimension is shown as a function of the number of layers. Additionally, (d) depicts a convergence of fidelity for the two algorithms with a truncation to Dₘₐₓ=3D;

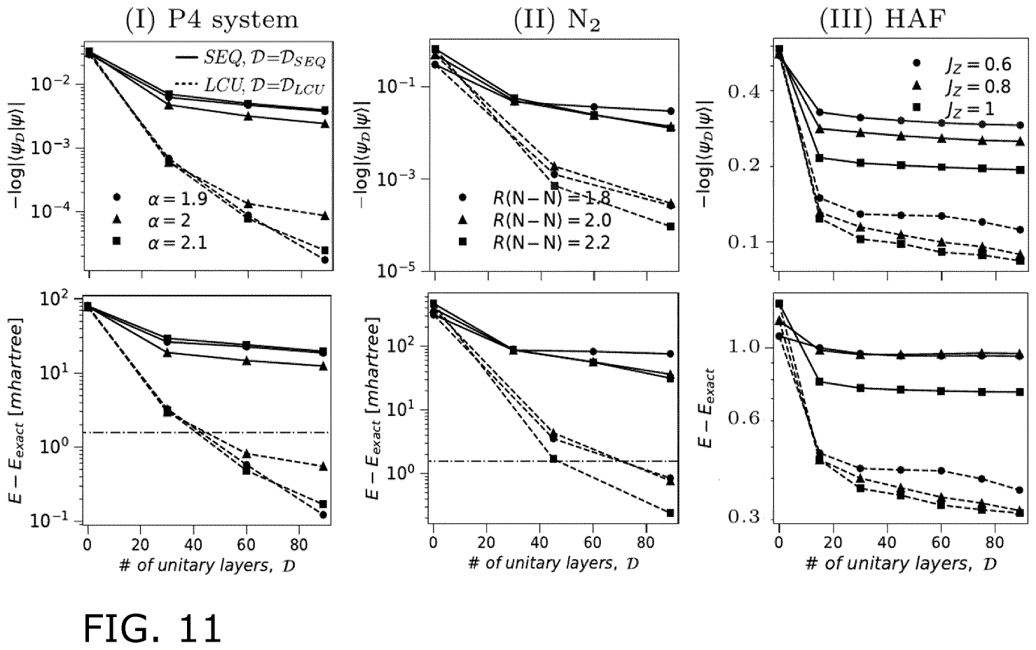

FIG. 11 is an illustration that includes a first row depicting fidelity, and a second row depicting energy error, with respect to a given ground state. A panel (I) depicts results for the P4 system as shown in FIG. 3a in a 6-31G basis set including 16 qubits. A panel (II) depicts data for the N2 molecule as illustrated in FIG. 3b with 20 qubits. A panel (III) depicts results for the HAF with 32 spins;

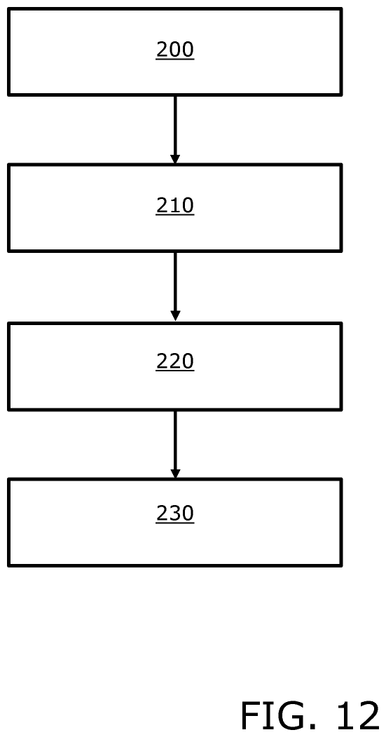

FIG. 12 is an illustration of steps of a method of implementing embodiments pursuant to the present disclosure; and

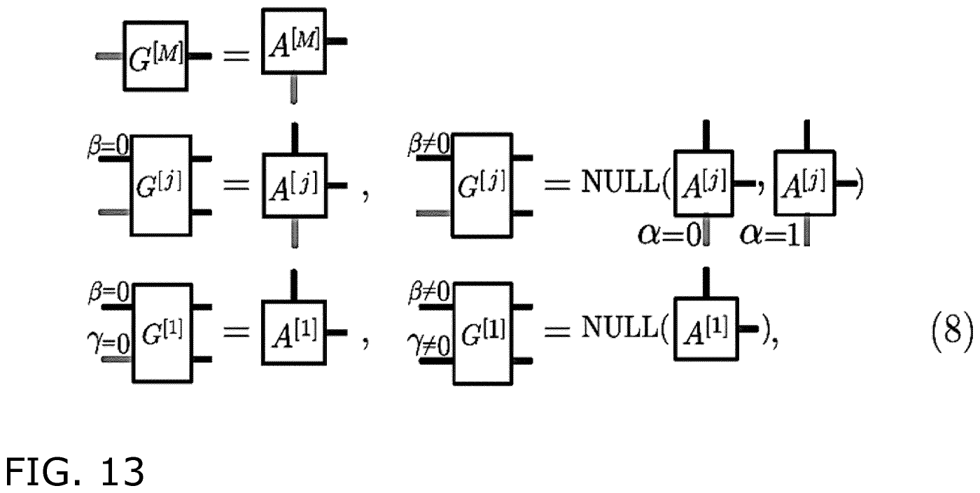

FIG. 13 is an illustration of quantum gates and their equivalents, for purposes of describing implementations of the present disclosure.

In the accompanying diagrams, an underlined number is employed to represent an item over which the underlined number is positioned or an item to which the underlined number is adjacent. When a number is non-underlined and accompanied by an associated arrow, the non-underlined number is used to identify a general item at which the arrow is pointing.

### DETAILED DESCRIPTION OF EMBODIMENTS

In general overview, contemporary computing hardware, for example configured to use Silicon-based integrated circuits and associated data memory devices for performing data processing, becomes more computationally powerful and faster as feature sizes of its integrated circuits become smaller. As circuit feature sizes approach nanometre scale, Heisenberg's uncertainty principle and quantum effects become more significant in integrated circuit design and operation. In the limit, using single particles, for example ions or photons, to represent data, namely in a form of qubits, represents a limit of miniaturization and provides a fastest computing performance, especially when phenomena such as superposition and entanglement are used; such an approach is used in contemporary quantum computers. A general introduction to quantum computation and quantum information is provided in a scientific publication “Quantum computations and quantum information”, Nagy et al., The International Journal of Parallel, Emergent and Distributed Systems, Vol 21, No. 1, February 2006, pp. 1-59.

In some cases, quantum computers and quantum computing systems may exploit the quantum nature of fields and particles to increase the computation speed compared to classical computers to enable solving computationally complex problems within timeframes suitable for practical applications. In classical processing of data, wherein the data is representative of real physical signals for example, many mathematical operations such as computations of means, correlations, Fourier transforms, Hadamard transforms and so forth are used for processing the data. The data to be processed may be considerable in size, for example Terabytes of information, even potentially Petabytes of information, for example acquired from sensor arrays, for example sequentially over a period of time. Processing time and associated latency for processing the data are important factors, for example in real-time control situations. A quantum computer is potentially capable of being configured to process large quantities of data in a highly efficient manner. However, a challenging contemporary technical problem is how to configure quantum computers in a most optimal manner to implement such data processing. For example, given a level noise generated by different elements of a quantum circuit, how the quantum computer should be used to perform a computational task (e.g., quantum computational task) is a technical problem, such that the noise generated during the computations does not impose a limit on the minimum computational error that can be achieved.

It is known practice to use a combination of a classical computer and a quantum computer when seeking to solve extremely complex problems; in the present disclosure, such a combination will be referred to as a quantum computing system. The classical computer uses Silicon integrated circuit devices that are configured to operate at substantially room temperature (circa +20° C.), whereas the quantum computer is configured to be cooled to cryogenic temperatures (circa −273° C.) in order to function most effectively. When tackling a given computing task, the task can be divided between execution on the classical computer and execution on the quantum computer. Moreover, for certain tasks, the classical computer will be more efficient than the quantum computer for handling simple computational tasks, whereas the quantum computer can potentially solve certain types of computation tasks that would be inefficient to perform on the classical computer. However, transferring tasks between the classical computer and the quantum computer has temporal overhead that is preferably reduced as much as possible in order to achieve an optimal computing performance for the quantum computing system.

When using such a tandem configuration of a classical computer and quantum computer, it is sometimes convenient, for example to enhance data processing throughput, to perform certain arithmetic computations on the quantum computer rather than on the classical computer. A technical problem that arises therefrom is how to configure a quantum computer most effectively for performing certain types of arithmetic computations in a manner that noise generated during the quantum computation does not impose a constraint on a total number of quantum operations that can be performed for a quantum computational task. Thus, some embodiments of the present disclosure are concerned with addressing a technical problem of configuring a classical computing system coupled in tandem with quantum computer in a manner to provides for more efficient computation of input data to generate corresponding processed output data, and also to reduce a computational error of the processed output data while keeping the quantum noise arising in the quantum computer below a threshold value.

In FIG. 1A, there is shown a schematic diagram of a quantum computing system 100. In some examples, the quantum computing system 100 may receive input data 101 from a data source and generate output data 102. In some cases, the input data 101 may comprise a real valued function and the output data 102 may comprise an expectation value of the real valued function with respect to a probability distribution. In some embodiments, the output data 102 may comprise an estimated quantum amplitude having an error below a threshold error. In some implementations, the quantum computing system 100 may include at least a classical computing system 110 (also referred to as being a classical computer or binary data computer) and a quantum computer 130 in communication with the binary data computer. In some cases, the classical computing system 110 may be in communication with the quantum computer 130. In some examples, the classical computing system 110 may be coupled in combination with the quantum computer 130. The classical computing system 110 may exchange data with the quantum computer 130 via one or more data links; the data links may, for example, be provided via use of a data highway. In some examples, the classical computing system 110 may comprise a non-transitory memory and at least one electronic processor configured to execute computer-executable instructions (e.g., software instructions, or program instructions) stored in the non-transitory memory. In some examples, the electronic processor may be implemented using Silicon integrated circuits that perform binary digital computations when is use. The one or more data processors can be configured to execute software instructions for processing the input data 101 to generate the output data 102 with assistance from a quantum computer 130 that is coupled to the classical computing system 110.

The memory may be a non-volatile memory, such as flash memory, a hard disk, magnetic disk memory, optical disk memory, or any other type of non-volatile memory. Furthermore, types of memory may include but are not limited to random access memory (“RAM”) and read-only memory (“ROM”). In some examples, the classical computing system 110 can be programmed to perform different procedures each implemented based on a different set of instructions.

In some cases, the electronic processor of the classical computing system 110 may execute the computer-executable instructions to receive input data 101 from a data source (e.g., from a sensor or a sensor network), to process the input data 101 to generate quantum computer input data 103, and to transmit the quantum computer input data 103 to the quantum computer 130. Additionally, the electronic processor of the classical computing system 110 may send configuration data 105 that is usable for configuring the quantum computer 130 (e.g., for configuring one or more quantum gates of the quantum computer 130). In some cases, the configuration data 105 may be stored in a memory of the classical computing system 110. In some other cases, electronic processing of the classical computing system 110 may generate configuration data 105 based at least in part on the data stored in a memory of the classical computing system 110. In some cases, the configuration data 105 may be provided by a user via a user interface (e.g., a user interface of the classical computing system 110).

In some examples, the quantum computer input data 103 may include optional data pertaining to instructions that may be executed or used by a controller of the quantum computer 130 to control and manage certain operational aspects of the quantum computer 130. In some examples, the optional data included in the quantum computer input data 103 may comprise instructions usable by a compiler (e.g., a quantum compiler) that is executed by the controller of the quantum computer 130, for example, to mitigate errors, and managing qubit placement.

In some cases, the data source includes, for example, one or more of: a data memory with data stored therein, a sensor arrangement that is configured to stream sensor data, a user interface. In some embodiments, the data memory source may include an electronic memory configured to store computer-executable data. The data may include, data received from a user, another computing system (e.g., classical or quantum computing system), or a sensor. In some examples, the sensor arrangement includes sensors generating sensor data in real-time, satellite streamed data, camera surveillance systems, genomic data PCR readout machines, MRI 3-D imaging machines, encryption devices and so forth. Alternatively or additionally, the input data 101 may be provided from other sources, for example financial trading data, parameters of physical systems to be modelled, and so forth.

The quantum computer 130 is used by the classical computing system 110 to perform particularly computationally complex tasks that would take the classical computing system 110 an unacceptably long period of time to process. The quantum computer 130 may comprise one or more quantum circuits acting on qubits configured to perform certain computationally complex tasks using quantum effects. In various implementations, the quantum computer 130 may include one or more qubits (e.g., an array of qubits) and one or more quantum gates. In some cases, the quantum gates may comprise one or more rotation gates. In some cases, the quantum circuits may comprise at least a portion of the one or more qubits and one or more quantum gates.

In some implementations, the quantum computer 130 includes in a range of 30 to 1000 qubits, more optionally in a range of 50 to 500 qubits, and various gates that enable quantum parameters such as qubit phase to be modified (namely, rotation operations R) as well as and entanglement and superposition operations between qubits to be performed. In some examples, the quantum computer 130 is configured to perform quantum noise reduction to reduce quantum computational errors arising therein. Moreover, in certain configurations of the quantum computer 130, its qubits and quantum gates are cooled to cryogenic temperatures when in operation, for example to within 1 Kelvin of absolute zero temperature. Optionally, the quantum computer 130 is implemented using photonic devices, cryogenic superconducting gates or ion traps, or a combination thereof. Optionally, the classical computing system 110 is spatially remote from the quantum computer 130, and data exchange occurs therebetween via one or more data communication links, for example an Internet data link.

In some cases, the program instructions can include a quantum amplitude estimation and/or amplification algorithms (e.g., maximum likelihood amplitude estimation algorithm), a variational approximation algorithm. In some cases, at least a portion of the quantum amplitude estimation and/or amplification algorithm and the variational approximation algorithm may be executed by the quantum computer 130 using one or more quantum circuits. In some examples, one or more quantum circuits of the quantum computing system may be configured based at least in part the input data 101. The quantum computer 130 may further process the outputs 104 received from the one or more quantum circuits to generate results usable for generating output data 102.

In some implementations, the quantum computer 130 may operate by processing a sequence of “shots”. In some cases, initial states may be defined (Ansatz) and each shot may include, preparing qubits having the defined initial state and performing a temporal sequence of quantum operations on the qubits to generate processed qubits having final states. In some cases, the initial states may comprise zero states. In some cases, the quantum computer 130 may generate the processed qubits having the final states by altering the initial states. In some cases, the quantum computer 130 may readout the final state of the processed qubits using measurement operations (e.g., quantum measurement operations).

In some implementations, the quantum computer 130 may include one or more quantum circuits configured to process qubits. In some cases, a number of quantum operations performed by quantum circuit and/or the longest path in the quantum circuit may be referred to as “quantum circuit depth”. In some cases, a path in the quantum circuit may comprise a sequence of quantum operations performed to transform the initial quantum states to the final quantum states.

Each shot may have a temporal duration that, in some cases, can be limited by quantum noise arising in the qubits, wherein the quantum noise can be manifest as qubit decoherence. In some examples, quantum noise arising in qubits increases as more quantum operations are performed on the qubits. As such, the quantum noise may increase with the corresponding quantum circuit depth. Despite such technological challenges, for certain types of computational tasks, the quantum computer 130 is extremely effective. Some of the methods disclosed herein may reduce the quantum circuit depth of the quantum circuits configured to generate outputs usable for computing a value of an arithmetic function based on values of one or more random variables associated with a probability distribution (e.g., a marginal distribution). Advantageously, these methods may reduce the quantum circuit depth without significantly increasing the computation time (e.g., a convergence time) and/or an error associated with the computed value.

In some cases, the configuration data 105 can be generated during execution of the aforesaid software instructions prior to run-time of quantum computer 130. In some examples, the configuration data 105 may include data usable for configuring one or more quantum circuits of the quantum computer 130 based at least in part on an arithmetic function. In some such cases, at least a portion of the software instructions may include a special compiler that upon execution generates the configuration data 105 by compiling another portion of instructions (e.g., configuration instructions), representing a configuration of the quantum computer 130. In some examples, the configuration data 105 may comprise data and/or instructions executable by the quantum computer 130 to configure the quantum circuits therein according to the configuration instructions.

For example, the TKET compiler, provided by Cambridge Quantum Computing Ltd., can convert a portion of the instructions into Hamiltonian functions that are subsequently processed during compilation to generate Pauli strings from which corresponding Pauli gadgets are derived, wherein the Pauli gadgets are then used to define configuration connections for quantum gates of the quantum computer 130, for example thereby creating a given quantum circuit. Such a process of converting Hamiltonian functions eventually to configuration connections for quantum gates is, for example, described in an IBM publication “Circuit optimization of Hamiltonian simulation by simultaneous diagonalization of Pauli clusters”, Ewout van den Berg and Kristan Temme, IBM T. J. Watson, Yorktown Height, NY, USA, 31 Mar. 2020. The entire contents of this IBM publication are incorporated by reference herein and made a part of this specification. Moreover, a publication “A compact ion-trap quantum computing demonstrator”, Pogorelov et al. describes a practical implementation of the quantum computer 130, the entire contents of this publication are incorporated by reference herein and made a part of this specification.

In some cases, a quantum compiler may convert a first quantum circuit or a symbolic form of a first quantum circuit to a second quantum circuit or a symbolic form of a second quantum circuit, wherein the second quantum circuit or the symbolic form of the second quantum circuit comprise ‘native gates’ for the target hardware. In implementations, the TKET compiler may reduce the corresponding quantum circuit depth (e.g., the quantum circuit depth of the second quantum circuit or its symbolic form). In some examples, the TKET compiler may reduce the quantum circuit depth by at least removing some manifest redundancies in the quantum circuit.

It will be appreciated that the aforesaid software instructions can relate to a plurality of types of computation that process data in manner to generate a technical effect, for example for implementing data encryption, data decryption, for filtering measurement data representative of measured physical parameters to reduce stochastic noise in the data, correlating measurement data to detect occurrence of a signal feature that is masked by stochastic noise and so forth. The quantum computing system 100 is thereby capable of providing a technical effect when processing data.

In some applications, computation may require an arithmetic function to be computed. In some cases, it is desirable that arithmetic computations are performed on the quantum computer 130 (e.g., to reduce the computation time). When reading out the aforesaid qubits, various methods can be used to reduce readout noise of the qubits; such methods include quantum amplitude estimation (QAE) requiring shots to be repeated to enable an average of output to be computed from which a best estimate of qubit value can be calculated. For achieving an optimal data processing throughput of the quantum computing system 100, it is often advantageous to reduce an amount of switching of tasks between the quantum computer 130 and the classical computing system 110.

Thus, from the foregoing, it will be appreciated that, in order to obtain a maximum performance from the quantum computing system 100, it is desirable that some of the aforesaid shots enable arithmetic computations to be performed on the quantum computer 130 in preference to using the classical computing system 110. In the present disclosure, there is provided an especially effective and efficient method of implementing such arithmetic computations using the quantum computer 130.

In overview, in embodiments of the present disclosure, there are used quantum circuits for implementing quantum chemistry simulation on a quantum computer apparatus including a classical computing arrangement couple in operation to a quantum computer arrangement, wherein the quantum circuits are configured to use parameter-free pre-entanglers as initial states for quantum algorithms. Such use of quantum circuits is used to address electronic structure problems, wherein there is utilized a new ansatz generated by a combination of
(i) a quantized version of a Canonical Transformation as proposed by Yanai and Chan [J. Chem. Phys. 124, 194106 (2006)]; and
(ii) a Complete Active Space Density Matrix Renormalization Group.
   This new ansatz allows to shift a computational burden between the quantum computer arrangement and the classical computer arrangement. When executing the quantum circuit, in a vicinity of multi-reference points in the potential energy surfaces of H₂O, N₂, BeH₂ and a associated P4 system, it is found that such a strategy requires 30% to 3000% less parameters than corresponding generalized unitary coupled cluster quantum circuits. Thus, embodiments of the present disclosure utilize a new algorithm to prepare Matrix Product States (MPS) based on a Linear Combination of Unitaries; the new algorithm is, for example, to compared to a known Sequential Unitary Algorithm proposed by Ran in [Phys. Rev. A 101, 032310 (2020)].

In the present disclosure, an orthogonal approach will be described, in particular for finding ground states of chemical Hamiltonians. Embodiments of the present disclosure use, instead of pretraining parameters of a quantum circuit, classical resources (for example, provided by the classical quantum computer arrangement) to find parameter-free quantum circuits, to which variational circuits are appended. It will be appreciated that, for problem sizes of practical use, this initialization places the quantum circuit close enough to a “narrow gorge” in an optimization landscape to ensure successful optimization.

The resulting quantum circuit, as used in embodiments of the present disclosure, comprises two stages:
(a) a pre-entangler stage, namely a parameter-free circuit that can be optimized classically in an efficient and scalable manner; and
(b) the quantum ansatz stage, namely a subsequent circuit of parameterised gates, as illustrated in FIG. 1B(a).
   A good pre-entangler fulfils two criteria:
(I) it exists in a manifold of quantum states that is easy to optimize over classically; and
(II) shallow quantum circuits can be found for the manifold of quantum states.
   In the present disclosure, there is focus on Matrix Product States (MPS) as a pre-entangler and a Canonical Transformation (CT) [14] is adapted from quantum chemistry as the quantum ansatz. In the present disclosure, there is described application of such a procedure to four problems in quantum chemistry that have strong electronic correlations.

The present disclosure implements a method that beneficially utilizes a combination of pre-entangle and quantum ansatz, wherein the following features pertain:
(i) MPS can be obtained efficiently by the Density Matrix Renormalization Group (DMRG) algorithm. Even though DMRG is most efficient in the presence of local one-dimensional interactions, the method has been shown to capture faithfully the Complete Active Space (CAS) of non-linear transition metal complexes [15] and has been carried out for up to 100 orbitals;
(ii) Significant work has been done on the conversion from MPS to the quantum circuits that prepare them. For example, Ran developed an iterative MPS preparation algorithm [16], based on the sequential generation with an ancilla [17]. In the present disclosure, there is extended the body of MPS preparation algorithms by a novel strategy that uses the Linear Combination of Unitaries that was introduced for executing Hamiltonian simulations on a quantum computer [18]; and
(iii) CT theory is a classical method designed for refining CAS-DMRG wavefunctions [14]. It is formulated in terms of unitary transformations [14]. The hardness of implementing those classically can be overcome by approximations—or, as is proposed in the present disclosure, by using a quantum computer arrangement for executing quantum computations.

Next, variation quantum eigensolvers based on canonical transformation theory will be described in greater detail in relation to embodiments of the present disclosure. To overcome the intractability of Equation (5), there is proposed to variationally optimize Equation (5) on a quantum computer arrangement. In the present disclosure, the DMRG-QCT method will be described before elucidating a reconfigured version of the methods that is capable of tackling multi-reference problems and its associated resource requirements.

Next, DMRG-QCT will be described in greater detail. DMRG-QCT uses DMRG to build static correlations in a given wavefunction on a classical computer arrangement and then uses a CT inspired variational ansatz that is referred to as Quantum Canonical Transformation (QCT) for adding dynamic correlations. As illustrated in FIG. 2, the DMRG-QCT approach comprises two steps (namely STEP 1, STEP 2) as will next be described.

In the first step STEP 1, assuming that there is an adequate assignment of molecular orbitals to a given active space, an algorithm used approximates a ground state of a Hamiltonian by using a DMRG method. As an output from the DMRG method, there is generated a MPS description |ψ₀ [symbol] of a ground state for a given bond dimension D. Although it is feasible to use exact diagonalization to construct a pre-entangler, embodiments of the present disclosure make use of a DMRG because a scalable algorithm if beneficially used for handling realistic problems with many qubits, and exact diagonalisation is not practical in such situations. A quantum circuit is found that prepares the MPS on a quantum computer. It is important for the unitary description to be reliable, namely the energy error of the unitary approximation should be sufficiently small, so as not to neglect too much of static correlations in the MPS description. Approaches to prepare MPS on the quantum computer is elucidated in greater detail in the next section.

The second step STEP 2 is to construct a variational circuit to describe dynamic correlations by coupling active orbitals with orbitals in the core and virtual spaces. Construction of the variation circuit is achieved by implementing the quantum circuit for e^{T} as defined in Equation (3). The exact circuit description of e^{T} is intractable and therefore an approximation is used, namely the first order Trotter-Suzuki decomposition [36]:

$${e}^{T} \approx {\prod }_{i} {e}^{{t}_{k} {τ}_{k}} , \qquad ( 6 )$$

where for brevity, it is written that T=Σₖtₖτₖ and the index k runs over all the single and double excitations except those which lie solely in the active space. Since τₖ does not commute, the decomposition introduces a subtlety about the ordering of exponentials in Equation (6) and it could be consequential if the ordering is not chosen carefully [37]. It has been pointed out in that variation in the performance of different orderings is high in the presence of strong static correlations. For the DMRG-QCT method, however, the description of static correlations has already been taken care of by the active space DMRQ computation, and so there is expected a small variance in the performance for different ordering in the case of QCT. With the approximation of U in Equation (6), the goal of the DMRG-QCT method is to minimize the ground state energy as given in Equation (7), namely:

$$E ( θ ) = 〈 {ψ}_{0} \vert {U}^{†} ( θ ) HU ( θ ) \vert {ψ}_{0} 〉 , \qquad ( 7 )$$

by measuring it in the quantum computer arrangement and updating θ until there is found a minimum ground state energy.

It is beneficial for understanding embodiments of the present disclosure to regard the DMRG-QCT method as an interpolation between purely classical and purely quantum computations. By choosing the active space to contain all orbitals, there is thereby provided a purely classical DMRG calculation. Conversely, in the limit of an empty active space, the fully quantum Generalized Initary Couple Cluster (GUCC) ansatz is recovered, wherein a variant of the commonly used unitary coupled cluster ansatz is suited for multi-reference computations.

Next, the expressibility of DMRG-QCT will be described in greater detail. To access the effectiveness of the DMRG-QCT ansatz method, four different molecular systems will be described. There systems contain points in their potential energy surfaces (PES) which exhibit strong multi-reference behaviour [20, 38, 39]. PES of H₂O and N₂ describe typical bond-breaking situations. In a first example, there is considered the one-parameter dissociation of the water molecule at the equilibrium angle (see FIG. 3a) and there is studied the ground state energy as the two hydrogen atoms are simultaneously pulled apart from the oxygen atom symmetrically. In the second example, the PES for the ground state of the Nitrogen molecule is considered that is parametrised by the stretching of N—N bond distance (see FIG. 3b). In a third example, the transition state of the reaction between Be and H₂ is considered. The parameterization of the PEW is expressed in FIG. 3c; x=0 indicates an equilibrium situation with BeH₂ in linear configuration, and as the value of x is increased, the system transitions into two non-interacting systems (Be and H₂) beyond the transition point. Finally, in a fourth example, there is considered the P4 model system that comprises two hydrogen molecules (see FIG. 3d). An H—H bond distance in the two molecules is kept fixed, while there is varied the distance in the two molecules denoted by a in the PES. As the value of α is increased, at α=2 bohr, the system obtains D₄ₕ symmetry. Such a higher symmetry leads to configurational quasi-degeneracy, and hence to an existence of strong static correlations in an associated wavefunction [20].

Embodiments of the present invention are susceptible to being implemented by using a known contemporary PySCF software package to compute one- and two-electron integrals [42]. For all quantum chemistry task, there is used a software product ChemMPS2 to perform the CAS-DMRG calculation [43-46]. The software product ChemMPS2 gives a symmetric MPS description of a given ground state while exploiting SU(2), U(1) and point group symmetries. To accurately probe the potential of QCT variational circuits in expressing synamic correlations, for the results provided below, there is considered the exact DMRG construction of the given ground state in the active space (namely, the bond dimension D used by DMRG is sufficiently large to represent the exact state). Furthermore, once the MPS description of the ground state is obtained, there is used a sequential unitary algorithm to obtain a corresponding quantum circuit that prepares the MPS.

Given a unitary construction of the ground state in the active space, there is used a known contemporary software product InQuanto [47], wherein InQuanto is a software platform that has been designed for executing computations for solving chemistry problems on a quantum computer arrangement, to generate a Jordan-Winger transformation of a fermionix Hamiltonian and to implement a corresponding QCT ansatz. It will be appreciate that QCT involves the application of a Trotter-Suzuki decomposition. To decompose e^{T} as point out in [37], there is implemented an ordering of double excitations before single excitations; such an ordering reduces corresponding quantum circuit depth and complexity, thereby generating more accurate final computational results using the quantum computer arrangement. The arrangement of double excitations

$${τ}_{ij}^{ab}$$

(labelled as abi j) is fixed to be in a lexical order. An exponential of the sum of the Pauli strings obtained from the Jordan-Wigner transformation of single

$$( {τ}_{i}^{a} )$$

or double

$$( {τ}_{ij}^{ab} )$$

excitations is beneficially constructed by Pauli gadgets [48], wherein the contemporary software product Ppytket is suitable to use to decompose the DMRG-QCT circuit into elementary CNOT and one-qubit unitary gates [49]. Such a Pytket compilation also performs certain non-trivial optimizations which lead to more efficient quantum circuits to be executed by the quantum circuit arrangement. To optimize the energy, in embodiments of the present disclosure, the variational parameters are iteratively updated in the QCT by using the Broyden-Fletcher-Goldfarb-Shanno (BFGS) algorithm [50-53].

Example results of using the DMRG-QCT method for the aforementioned molecules are illustrated in FIG. 4, wherein notations (•e, •o) at the top of each plot is used to specify the number of electrons and orbitals in the active space used for DMRG calculations. Data for Hartess-Fock (HF) is shown, wherein there is used configuration intercation with single and double excitations (CISD) and coupled cluster with single and double excitations (CCSD), for example as aforementioned. There is then computed energys error of different methods with respect to the full configuration intercation method in a given basis. As expected, the classical single-reference methods perform poorly. The error of CISD is substantial for stretched bonds, as shown in FIG. 4(a, b)), and high symmetry points as shown in FIG. 4(c, d). CCSD becomes non-variational close to the multi-reference points.

The data labeled as DMRG in FIG. 4 is an illustration of the energy error in the absence of dynamic correlations; here, the variational QCT circuit acts trivially and static correlations generated by the pre-entangling MPS circuit completely determine the energy approximation. In FIG. 4, there are also shown results for second order N-electron valence state perturbation theory (NEVPT2) applied on top of the multi-reference wavefunction from DMRG. Energy errors for DMRG-QCT with singles labeled as QCT-S in FIG. 4 illustrate the lowering of energies when the QCT circuit only contains variational parameters for the single excitations. It is to be noted that unitary coupled cluster ansatzes with only single excitations are typically not studied in the literature. This is due to Thouless' Theorem [54] which provides that single excitation clusters cannot lower the energy of a single reference wavefunction. It is a distinct feature of QCT-S that it manages to lower the energy by building dynamic correlations on top of the static MPS quantum circuit.

DMRG-QCT with single and double excitation, refereed to as “QCT-SD”, is able to find a state with an error that is less than the chemical accuracy on H₂O and BeH₂. Although the energy error for NEVPT2 is small for FIG. 4 (a, b), the error fails to achieve chemical accuracy for BeH₂ and P4 systems. Moreover, even in FIG. 4 (a, b), the energy error of NEVPT2 is not satisfactory in a single-reference regime. It is found that the nonparallelism error (NPE) [20], that is defined to be the absolute difference of maximum and minimum energy error, for NEVPT2 method to be 3.59 mH, 9.93 mH 16.21 mH, and 1.75 mH for the four plots in FIG. 4. Conversely, for the QCT-SD method, the NPE is 0.30 mH and 1.15 mH for FIG. 4 (a, c). On account of computational and circuit requirements, the present disclosure does not describe the DMRG-QCT ansatz with single and double excitations for N₂ and P4 (see FIG. 4 (b, d)); in contrast, it will be appreciated that the GUCC-SD algorithm is computationally intractable for all the simulation examples which are illustrated in the present disclosure.

In the present disclosure, the performance of the QCT ansatz with imperfect static construction by the DMRG method is also described. In FIG. 5, there is shown an illustration of the effect on the performance of DMRG-QCT ansatz as the bond dimension of MPS is changed that describes the reference state |ψ₀ [symbol] in (1). It will be appreciated that both the QCT-S and QCT-SD show certain resilience against imperfect MPS construction by DMRG and the QCT-SD ansatz maintains energy error below chemical accuracy. For a severe reduction in the bond dimension D (which in the limit of D→1 corresponds to a single Hartree-Fock reference) QCT does not yield energies within chemical accuracy. At a low bond dimension, CT-singles and CT-SD perform similarly, whereas for high bond dimensions, CT-SD is very close to being exact. Data for FIG. 5 also suggests a preference for adding CT single excitations over increasing the bond dimension utilized by the DMRG, for example the D=6 CT-S energy is already below the full active space energy.

Next, an efficiency of DMRG-QCT will be described in greater detail. There is described the circuit complexity of implementing the DMRG-QCT ansatz and analyzing it in comparison to the GUCC ansatz. Moreover, there is inspected the scaling of the number of variational parameters as a function of the number of spin orbitals or qubits n. It is expected that the number of variational parameters is the most important factor in determining the cost (both the circuit requirements and time complexity) of variational quantum eigensolvers. A reduction in the number of parameters directly leads to a decrease in the depth and the elementary gate count. Furthermore, a decrease is also provided in the number of iterations required, namely the evaluation of energy by the quantum computer and the update of variation parameters by the classical optimizer. Estimation of the energy by the quantum computer is very expensive due to the enormous number of Pauli strings in the chemical Hamiltonian and so any reduction in the number of variational iterations leads to a substantial reduction in the runtime of the algorithm.

Each variational parameter corresponds to an excitation (single or double) in the first order Trotter-Suzuki approximation of e^{T} in (6), and so the number of parameters is equal to the number of excitations. Furthermore, for the QCT ansatz, the number of electrons in the active space or the number of electrons in total does not change the number of excitations as it is also the case for GUCC ansatz. In FIG. 6a, there is shown a plot of scaling of variational parameters by counting the number of excitations for GUCC and DMRG-QCT ansatzes with respect to the number of spin orbitals. If m is the number of orbitals (namely, m=n/2), then for the GUCC-D, the number of excitations is given by

$$\frac{2}{3} ( \begin{matrix}m \\ 2\end{matrix} ) ( \begin{matrix}m - 2 \\ 2\end{matrix} ) + {( \begin{matrix}m \\ 2\end{matrix} )}^{2} .$$

$$( first term ) ( second term )$$

The first (second) term counts for double excitations where the complete action of excitation is one (two) spin channels. The factor of ⅔ in the first term accounts for the reduction obtained by enforcing the reduction obtained by enforcing the azimuthal spin symmetry. In the case of the DMRG-QCT ansatz, different splits (c, a, v) are considered by dividing n spin orbitals into core (c), active (a), and virtual (v) orbitals. Note that in each split (c, a, v), c=v (namely, the number of core and virtual orbitals is the same). As the size of the active space is increased, the number of variational parameters decreases (see FIG. 6a (Inset)). The reduction is more noticeable for large n, for example α=0.8 n, wherein there is achieved a reduction by a factor of 0.4. Importantly, the reduction is more pronounced in a split with c<a<<v that represents a typical MR calculation. For example, for the split (0.05n, 0.15n, 0.8n), there is achieved a reduction in the number of variational parameters by a factor of 0.1. In FIG. 6a, there is shown a plot of the scaling of GUCC-S ansatz that makes an upper bouns for the scaling of QCT-S. It can be seen clearly that the growth in the number of parameters for GUCC-S (or CT-S) is almost negligible compared to ansatzed with double excitations. Hence, QCT-S ansatz can be helpful in certain multi-reference situations where it can lower the energy without any overhead. It is important to recognize that there is used a minimal basis for three of the four multi-reference problems due to the computational requirements. The use of minimal basis makes it difficult to rigorously access the performance of a multi-reference technique because of the small (that is typically the case) dynamic correlation energy, and it is relatively easier to achieve chemical accuracy. However, there is not observe any inconsistency in the performance of DMRG-QCT for all the multi-reference problems which have been studied during development of embodiments of the present disclosure, such that it is expected to observe similar performance if beyond a minimal basis is considered.

In FIG. 6(b, c), there is shown a cost of implementing an excitations/variational parameter in terms of circuit depth and elementary gates for a system size up to n=36. There is obtained an almost perfect linear scaling for each of the ansatzes. The prefactor for linear scaling is very high, notably for the gate count, where it is 46. From the scaling of variation parameters, gates, and circuit depth, it is expected that the DMRG-QCT ansatz will gain a significant reduction in cost with respect to GUC, especially for typical active spaces with c<a<<v.

In FIG. 9A, there are illustrated resource requirements for the problems considered in FIG. 4. Gate count and circuit depth for the QCT also include the cost for the MPS state preparation circuit. Despite those extra costs, there is observed a saving in all cost metrics of 20 to 40% for QCT-SD and 80 to 97% for QCT-S for the molecules considered. Note that the relative savings increase with system size.

Next, there will be described the unitary circuits that are required to prepare a MPS approximately with the physical dimension d and the virtual bond dimension D. To work with qubits, here it is assumed that d=2. To commence, there will be reviewed the sequential unitary (SEQ) algorithm required to construct a MPS. Thereafter, the effects of unitary freedom in the SEQ description of the MPS will be described.

Next, there is described a Linear Combination of Unitaries (LCU) algorithm as an alternative to the SEQ approach. Various aspects of SEQ and LCU algorithms will be described and their relative performance is compared.

In FIG. 13, a second row therein defines unitaries corresponding to intermediate tensors of the MPS. Each index has a dimension 2 and matching line colours on the two sides of each identity specifies the indices of every G^{[j]}. Every input of NULL ( . . . ) is a vector in d×D=4 dimensional space and its output represents an orthogonal basis for the null space of input vectors. A cascaded action of unitaries obtained by contracting the top-right index of G^{[j]} with the bottom-left index of G^{[j+1]} gives a global unitary U and the action of U onto the product state gives the MPS, namely |ψ [symbol] =U|00 . . . 0 [symbol] .

In the case of a generic MPS |ψ [symbol] with D>d, Ran realized that U^{†} acts as a disentangler. This insight leads to an interactive algorithm; it starts by initializing |ψ₀ [symbol] =|ψ [symbol] and each iteration consists of the compressing the MPS to bond dimension d and applying disentangling unitaries as follows:

$$\vert {ψ}_{i} 〉 {{\to }^{Compress MPS}}_{from D to d} {\vert {\tilde{ψ}}_{i} 〉}_{{=}_{{U}_{i} \vert 00 … 〉}} {{\to }^{disentangle}}_{compress to {D}_{max}} {\vert {ψ}_{i + 1} 〉}_{{=}_{{U}_{i}^{†} \vert {ψ}_{i} 〉}} \qquad ( 9 )$$

Here, there is used |\tilde{ψ} [symbol] to denote an truncated approximation of |ψ [symbol] to bond dimension D=2. A unitary Uᵢ is obtained as described earlier. The sequential application of unitaries is expected to transform |ψᵢ [symbol] to product states, namely

$$\vert 00 … 0 〉 = … {U}_{2}^{†} {U}_{1}^{†} {U}_{0}^{†} \vert ψ 〉$$

and the inverse action of [symbol] _{SEQ} layers of these unitaries

$$\vert {ψ}_{{𝒟}_{SEQ}} 〉 = {U}_{0} {U}_{1} … {U}_{{𝒟}_{𝒮 ε 𝒬}} \vert 00 … 0 〉 \qquad ( 10 )$$

gives the SEQ construction of a MPS.

An important aspect of the SEQ algorithm is the freedom in the definition of local tensors. The choice of the orthogonal basis for the null spaces used in the definition of local unitaries G^{[j]}'s is not unique. In the following, there is analyzed the performance of the SEQ algorithm with different choices of orthonormal basis at each unitary layer for the ground state |ψ [symbol] of the Nitrogen dimer (N₂). In FIG. 7 (A, b), there is shown a convergence in fidelity and energy error for the unitary approximation | [symbol] [symbol] _{SEQ} [symbol] as a function of unitary layers. Distinct lines depict the behaviour of fidelity and error for arbitrary choices of null space basis in the local unitaries. Each of the trajectories corresponds to a corresponding particular choice of null space basis. It will be appreciated that the choice of unitaries can improve the fidelity convergence, but not qualitatively. The crossing between different lines also suggests that the greedy optimization of unitaries at each layer would not necessarily lead to a globally optimal choice. Another way to exploit this unitary freedom is to use it in a gate synthesis (namely decomposition into one-qubit rotations and CNOT gates) of two qubit unitaries. By using isometric circuit techniques, it is feasible to implement these state preparation unitaries (namely G^{[j]}'s) with savings in the number of CNOTs from 3 to 2 and one-qubit gates from 8 to 6 [57, 58].

Next, there will be described a use of a linear combination of unitaries (LCU) algorithm. There is herewith introduced a new method to prepare a MPS, wherein the MPS is approximated as:

$$\vert {ψ}_{{𝒟}_{LCU}} 〉 = ( {U}_{0} + {κ}_{1} {U}_{1} + {κ}_{2} {U}_{2} + … ) \vert 00 … 0 〉 , \qquad ( 11 )$$

wherein each Uᵢ|00 . . . 0 [symbol] corresponds to a MPS with D=2 and the κᵢ's are variational parameters. The generated state is a MPS that is block-diagonal, and it is envisaged that it better captures symmetry structures of the target wavefunction. Moreover, in contrast to the product of unitaries, a generic linear combination of unitaries is not unitary, so in principle it allows for doing highly non-trivial actions on the product state.

Algorithm 1 Find LCU approximation of |ψ

[symbol]

| | |
|---|---|
| 1: | procedure LCU(\|ψ [symbol] , [symbol] _{LCU}) [symbol] [symbol] _{LCU} is the # of Uᵢ's in |
| | (11) |
| 2: | \|ψ₀ [symbol] ← Compress(\|ψ [symbol] , D = 2) [symbol] truncate MPS to D |
| 3: | U₀ ← Unitary(\|ψ₀ [symbol] ) |
| 4: | for i ← 1 to [symbol] _{LCU} do |
| 5: | \|ψᵢ₋₁ [symbol] ₚᵣₒⱼ ← Proj(\|ψ [symbol] , \|ψᵢ₋₁ [symbol] ) [symbol] projection of \|ψ [symbol] |
| 6: | \|rᵢ [symbol] ← Compress(\|ψ [symbol] − (\|ψᵢ₋₁ [symbol] ₚᵣₒⱼ , D = 2) |
| 7: | κᵢ ← Optimize(\|ψ [symbol] , \|rᵢ [symbol] , \|ψᵢ₋₁ [symbol] ) |
| 8: | Uᵢ < Unitary(\|rᵢ [symbol] ) |
| 9: | \|ψᵢ [symbol] ← \|ψᵢ₋₁ [symbol] + κᵢ \|rᵢ [symbol] |
| 10: | \|ψᵢ [symbol] ← Compress(\|ψᵢ [symbol] , D = Dₘₐₓ) |
| 11: | end for |
| 12: | return κ, U |
| 13: | end procedure |

The LCU algorithm works in an iterative fashion by estimating the residual of the target MPS and the current approximation (see Algorithm 1 above for an implementation). The algorithm begins by compressing |ψ [symbol] to D=2 and uses it to initialize |ψ₀ [symbol] . Thereafter, it is feasible to find the exact unitary representation of |ψ₀ [symbol] using the method defined in (8) such that |ψ₀ [symbol] =U₀|00 . . . 0 [symbol] . At the start of each iteration, there is computed the projection of the target state |ψ [symbol] on the current approximation |ψᵢ₋₁ [symbol] , namely:

$${\vert {ψ}_{i - 1} 〉}_{proj} = \frac{〈 {ψ}_{i - 1} \vert ψ 〉}{〈 {ψ}_{i - 1} \vert {ψ}_{i - 1} 〉} \vert {ψ}_{i - 1} 〉 . \qquad ( 12 )$$

There is next computed the residual |rᵢ [symbol] by subtracting |ψᵢ₋₁ [symbol] ₚᵣₒⱼ from the |ψ [symbol] and compressing of the resulting MPS to D=d=2. At this point, it is important to note that it is feasible to also define a residual by taking a difference of |ψ [symbol] and |ψᵢ₋₁ [symbol] ; however, such a definition in general leads to a slowdown in the convergence of LCU. There is found numerically that the residual obtained from |ψᵢ₋₁ [symbol] ₚᵣₒⱼ performs better at including features that are relevant for achieving high fidelity with |ψ [symbol] . Next, there is optimized for the variational parameter κᵢ, such that the normalized overlap between |ψ [symbol] and |ψᵢ₋₁ [symbol] +κᵢ|rᵢ [symbol] is maximized. The one parameter optimization is very fast given the fact that fidelities can be computed very quickly for MPS. Furthermore, without any loss of optimality, the optimization to κᵢ>0. is restricted. Once there is obtained κᵢ, it is feasible to set a new |ψᵢ₋₁ [symbol] ; if its bond dimension exceeds Dₘₐₓ, it is beneficial to compress it.

Next, there are considered important questions about the circuit implementation of the linear combination of unitaries. Since the linear combination of unitaries is not a unitary, to achieve such an operation on a quantum device, one needs to resort to a non-deterministic implementation. Beneficially, there is adapted the implementation given in while employing the gray code construction [59-61] (see FIG. 8). The box bordered by the dashed line in FIG. 8 indicates the implementation of ┌lg [symbol] _{LCU}┐ controls for the unitaries which are ordered by their gray code and this leads to a significant reduction in the number Toffoli and hence the CNOT and one-qubit gates required. For the implementation for the multi-control unitary gates, there are two options. Naively, one could use a decomposition whose two qubit gate count scales quadratically in order to avoid deep circuits, ┌lg [symbol] _{LCU}┐−1 wherein further ancilla qubits can be added (referred to as “work qubits” in FIG. 8) [62]. Using such a construction, the multi-control unitary gates can be implemented with a number of two qubit gates that is linear in the number of controls, and hence logarithmic in the number of layers [symbol] _{LCU} (which grows linearly with increasing bond dimension). Although there is a need for a sizeable number of ancilla qubits, it is feasible to compute quantum chemistry problems on a NISQ device having a moderate number of qubits. In FIG. 8, a first column of the multi-qubit B is initialized with coefficients κᵢ. The rest of the B is set with an orthogonal subspace to make B a unitary. The circuit of FIG. 8 applies the right unitary combination when there is measured zero on ┌lg [symbol] _{LCU}┐ ancilla qubits.

The cost of LCU circuits in terms of elementary gates is dictated by the cost of realizing control of two-qubit unitaries. To implement control of two-qubit gates, there is beneficially also utilized their corresponding isometric structure (namely, only first columns of these unitaries are relevant, as discussed earlier in the foregoing). Furthermore, since only the first column of multi-qubit gates B and B^{†} are relevant, they can be realized efficiently by using the state preparation strategy outline in [63]. In the worst case [symbol] (lg [symbol] _{LCU} log lg [symbol] _{LCU}) CNOT and one-qubit gates are required to implement B While the overall cost of implementing the LCU circuit is linear in [symbol] _{LCU}, the scaling prefactor is fairly large. If n is the number of qubits, then there is needed roughly 24n [symbol] _{LCU} CNOT and 31n [symbol] _{LUC} one-qubit gates. In contradistinction, to implement the SEQ circuit, the number of CNOTS and one-qubit gates scales as 2n [symbol] _{SEQ} and 6n [symbol] _{SEQ} respectively. The better scaling of the SEQ circuit makes the SEQ algorithm more favourable in situations where it achieves the desired error in the energy when performing a quantum chemistry simulation.

Beneficially, there is analyzed the probability of measuring zero on ancilla qubits for different systems. It is found that the probability of converging to a reasonable value even for sufficiently large [symbol] _{LCU} is as provided in FIG. 9. Although the convergence of the probability can be attributed to the decay in the LCU coefficient (see FIG. 9 (Inset)), the fact that the limiting probability is fairly large for electronic structure problems makes the LCU algorithm especially useful when it is applied for preparing the ground states of chemical Hamiltonians. Furthermore, such an approach also alleviates a need for using amplitude amplification or oblivious amplitude amplification that could incur considerable overhead [64-66].

Next, numerical analysis of SEQ and LCU algorithms will be described in greater detail. An important trait of SEQ algorithm as also noted in is the existence of plateaus. Similar behaviour of plateaus has also been observed in a different context, which involved finding mixed state purifications [67]. In each iteration (9), the application of disentangling unitaries raises the Schmidt rank and, hence, the bond dimension of the MPS. The latter increases exponentially with the number of layers [symbol] _{SEQ} and one must truncate it to some [symbol] ₘₐₓ in order to keep the computationally viable. It is beneficial to analyze the behaviour of Schmidt values (for the cut access maximum bond dimension) for the SEQ algorithm without any truncation of Dₘₐₓ (see graph (a) in FIG. 10A and FIG. 10B (I, II)). The earlier application of disentangling unitaries on the MPS introduces low weight Schmidt values, and this behaviour holds for all different models that have been studied when developing embodiments of the present disclosure. It is important to note that the longterm behaviour of Schmidt values is quite distinct for the conventional many body in contrast to the chemical systems as can be seen in FIG. 10A and FIG. 10B (I, II)a. In FIG. 10A and FIG. 10B (I, II)c, wherein there are shown the multiplicative increase in the bond dimension of the MPS before it saturates to a maximum value. Naively, it would be expected to discard low weight Schmidt values (introduced by disentangling unitaries) without consequences. But this is not the case and loss introduced by compressing |ψᵢ [symbol] to Dₘₐₓ leads to the emergence of plateau as can be seen in FIG. 10A and FIG. 10B (I, II) d. The convergence slowdown is more pronounces in the energy error (see FIG. 7b) where it flattens well before achieving the chemical accuracy, which contributes significantly to the usefulness of SEQ algorithms for CT ansatz.

Aforesaid LCU is an efficient classical algorithm even in the absence of any truncation. During each iteration of the LCU algorithm, the bond dimension of approximate MPS |ψᵢ [symbol] increases in an additive manner (i.e. the bond dimension of |ψᵢ [symbol] is only 2i). This is in contrast to the SEQ algorithm, wherein the bond dimension is expected to be [symbol] (2ⁱ). FIG. 10A and FIG. 10B (I, II) c is an illustration of the qualitative difference in the growth of bond dimension for the SEQ and LCU algorithms. In FIG. 10A and FIG. 10B (I, II) b, there are shown the Schmidt values of |ψᵢ [symbol] for the LCU algorithm, wherein the Schmidt values include quite distinct features. Furthermore, in FIG. 10A and FIG. 10B (I, II) d, there is shown the long run behaviour of the LCU algorithm where it continues to increase fidelity with respect to the target state even for large [symbol] , wherein the presence of a plateau is not quite pronounced.

In developing embodiments of the present disclosure, benchmark performances of SEQ and LCU algorithms for different chemical and spin systems were implemented. To use a given MPS preparation method in the context of chemical systems, for example for the DMRG-QCT ansatz, it was found that it is important for the method to achieve error in energy density below the chemical accuracy. The energy error induced by the unitary approximation of a method makes a lower bound for the total energy error of the DMRG-QCT ansatz. In FIG. 1, there is shown the behaviour of SEQ and LCU algorithms for the fidelity with true ground state and energy error. In the case of chemical systems (FIG. 11 (I, II)), there is shown in data in the multi-reference regime while for the spin problem (FIG. 11 (III)), there is shown the behaviour in the vicinity of the critical point. Although the resource overhead for implementing [symbol] _{LCU} unitary layers in the linear combination is significantly high, the LCU algorithm always manages to find the error in the energy below chemical accuracy. Moreover, the LCU algorithm also achieves a lower error in the case of HAF.

In summary and overview of the foregoing disclosure, there is proposed a general method for overcoming some of the challenges of variational quantum algorithms. The general method comprises two steps:
Step 1: a classically found trial wavefunction is prepared on a quantum computer; and
Step 2: the trial wavefunction is subsequently refined using short variational quantum circuits.

The general method is susceptible to being applied in the context of quantum chemistry, where one natural choice is to assign the static and variational parts of the circuit to the static and dynamic correlations of the wavefunction, respectively. In embodiments of the present disclosure, it is found that this general method leads to three kinds of advantages:
(i) existing ansatzes, for example GUCC ansatz, can be extended which in the case of embodiments of the present disclosure leads to a system-size independent reduction of variational parameters by 30 to 80%, depending on the relative size of the active space;
(ii) the method provides a process to shift the computational burden between classical and quantum processors, for example the computation can be tuned from a purely classical computation (where a given full system is in the active space) to a purely quantum computation (where no active space precalculation is done); and
(iii) importantly, this method opens up a possibility of new, shallow ansatzes, that have previously not been hitherto considered.
   The availability of an entangled active space trial wavefunction allows the use of the QCT-S ansatz, which for a 100-spin orbitals contains roughly one thousand times less variational parameters than the GUCC ansatz; this is potentially a huge advantage in that simulation of much larger simulations of chemical systems is feasible on contemporary NISQ computing devices.

One important step in the proposed general method is the approximate implementation of MPS on a given quantum computer, for example a NISQ-era quantum computer. There is thus provided a new algorithm for that purpose, namely the LCU algorithm. The LCU algorithm has been compared to the known SEQ algorithm from known literature, wherein the LCU algorithm is found to be more expressive, albeit requiring a larger constant prefactor in its circuit decomposition. Moreover, it has been found that the unitary freedom present in the canonical form of the MPS can be used both for the optimisation of the disentangler and for circuit synthesis, and it is concluded that the latter application is generally more powerful.

In the foregoing, in describing embodiments of the present disclosure, there have been provided an optional realization of a pre-entangler approach by way of DMRG-QCT, wherein there is provided a method that is fairly flexible and can be utilized in a straightforward way to complement the capabilities of other techniques such as Adapt-VQE and symmetry preserving ansatzes [68, 69]. Additionally, the method including the pre-entangler approach can additionally advantageously be used in the domains of quantum optimization and machine learning.

Optionally, It is also possible in embodiments of the present disclosure to prepare MPS by using a hybrid combination of SEQ and LCU procedures. A first manner in which to implement the combination is to modify Equation (10) to get an ansatz that is a sequence of operators, wherein each operator itself is a linear combination of unitaries and hence not necessarily a unitary. A second manner in which to implement the combination is a linear combination of sequential unitaries (i.e. each unitary in the sum is a product of unitaries) in Equation (11). From these two manners, the second manner can be implemented with minor changes from Algorithm 1. In an era of NISQ-device resources, these generalized two manners are capable of providing better trade-offs between accuracy and circuit requirements for tensor state preparation.

It will be appreciated that there are other ways for preparing MPS, for example it has been proposed in Equation (70) to optimize unitary layers in the sequential unitary ansatz by automatic differentiation which leads to further optimal approximations. It is expected that substantial improvements are feasible also for the LCU algorithm if the Algorithm 1 is substituted with a similar unitary optimization procedure; however, there would be incurred increased classical computational overhead, wherein there will result in higher-quality states within the variational manifold define by Equation (11). Optionally, in embodiments of the present disclosure, pre-entanglers can be used, wherein the pre-entanglers comprise more generic tensor networks as given in [71] via Quantum Circuit Tensor Networks. Optionally, pre-entanglers prepared by using an adiabatic algorithm [72] are used in embodiments of the present disclosure. Moreover, the LCU algorithm as described in the present disclosure can be used in other settings, for example for preparing low-energy states for quantum algorithms based on time series [73].

In the foregoing, in describing embodiments of the present disclosure, there is described CT Theory, wherein there exist other methods to recover dynamical correlation from the active space. Moreover, n-electron valence second-order perturbation theory or adiabatic connection are optionally used in embodiments of the present disclosure.

Referring next to FIG. 12, there are shown steps of a method pursuant to the present disclosure to implement a simulation of a chemical system. The method is implemented using a hybrid computing arrangement wherein the hybrid computing arrangement includes a combination of a classical computer coupled to a quantum computer, wherein the hybrid computing arrangement is configured in use to receive input data and to generate corresponding processed output data from the input data. The method includes steps 200 to 230, wherein:
Step 200 includes: configuring the classical computer to receive information describing a chemical system in the input data.
Step 210 includes: configuring the classical computer to process the information describing the chemical system using a pre-entangler algorithm and a fixed circuit algorithm to generate a quantum ansatz defining initial values for a quantum circuit computation, and a Hamiltonian from which is generated a variational circuit algorithm.
Step 220 includes: configuring the quantum computer to compute using the quantum ansatz and the variational circuit algorithm a corresponding quantum circuit to generate quantum computations results.
Step 230 includes: configuring the classical computer to process the quantum computational results to generate the output data including information describing an electron orbital simulation of the chemical system.

Optionally, the method includes configuring the hybrid computing arrangement:
(i) to assign molecular orbits to an active space based on the molecular system; wherein the orbits are susceptible to occupying core, virtual and active spaces;
(ii) to use an algorithm to approximate ground states of the Hamiltonian by using a MSRG algorithm to generate a Matrix Product States (MPS) description |ψ₀ [symbol] of a ground state for a given bond dimension D;
(iii) to find a quantum circuit that prepares the MPS description |ψ₀ [symbol] on the quantum computer;
(iv) to construct a variational quantum circuit to describe dynamic correlations by coupling active orbitals in the core and active spaces; and
(v) from results of executing the quantum circuit to minimize ground state energies to generate the output results.

Modifications to embodiments of the present disclosure described in the foregoing are possible without departing from the scope of the present disclosure as defined by the accompanying claims. Expressions such as “including”, “comprising”, “incorporating”, “consisting of”, “have”, “is” used to describe and claim the present invention are intended to be construed in a non-exclusive manner, namely allowing for items, components or elements not explicitly described also to be present. Reference to the singular is also to be construed to relate to the plural; as an example, “at least one of” indicates “one of” in an example, and “a plurality of” in another example; moreover, “one or more” is to be construed in a likewise manner.

The phrases “in an embodiment”, “according to an embodiment” and the like generally mean the particular feature, structure, or characteristic following the phrase is included in at least one embodiment of the present disclosure, and may be included in more than one embodiment of the present disclosure. Importantly, such phrases do not necessarily refer to the same embodiment.

The term “computer” or “computing-based device” is used herein to refer to any device with processing capability such that it executes instructions. Those skilled in the art will realize that such processing capabilities are incorporated into many different devices and therefore the terms “computer” and “computing-based device” each include personal computers (PCs), servers, mobile telephones (including smart phones), tablet computers, set-top boxes, media players, games consoles, personal digital assistants, wearable computers, and many other devices.

The methods described herein are performed, in some examples, by software in machine readable form on a tangible, non-transitory storage medium, e.g., in the form of a computer program comprising computer program code adapted to perform the operations of one or more of the methods described herein when the program is run on a computer and where the computer program may be embodied on a non-transitory computer readable medium. The software is suitable for execution on a parallel processor or a serial processor such that the method operations may be carried out in any suitable order, or simultaneously.

This acknowledges that software is a valuable, separately tradable commodity. It is intended to encompass software, which runs on or controls “dumb” or standard hardware, to carry out the desired functions. It is also intended to encompass software which “describes” or defines the configuration of hardware, such as HDL (hardware description language) software, as is used for designing silicon chips, or for configuring universal programmable chips, to carry out desired functions.

Those skilled in the art will realize that storage devices utilized to store program instructions are optionally distributed across a network. For example, a remote computer is able to store an example of the process described as software. A local or terminal computer is able to access the remote computer and download a part or all of the software to run the program. Alternatively, the local computer may download pieces of the software as needed, or execute some software instructions at the local terminal and some at the remote computer (or computer network). Those skilled in the art will also realize that by utilizing conventional techniques known to those skilled in the art that all, or a portion of the software instructions may be carried out by a dedicated circuit, such as a digital signal processor (DSP), programmable logic array, or the like.

Any range or device value given herein may be extended or altered without losing the effect sought, as will be apparent to the skilled person.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

It will be understood that the benefits and advantages described above may relate to one embodiment or may relate to several embodiments. The embodiments are not limited to those that solve any or all of the stated problems or those that have any or all of the stated benefits and advantages. No single feature or group of features is necessary or indispensable to every embodiment.

Conditional language used herein, such as, among others, “can,” “could,” “might,” “may,” “e.g.,” and the like, unless specifically stated otherwise, or otherwise understood within the context as used, is generally intended to convey that certain embodiments include, while other embodiments do not include, certain features, elements and/or steps. Thus, such conditional language is not generally intended to imply that features, elements, and/or steps are in any way required for one or more embodiments or that one or more embodiments necessarily include logic for deciding, with or without author input or prompting, whether these features, elements, and/or steps are included or are to be performed in any particular embodiment. The terms “comprising,” “including,” “having,” and the like are synonymous and are used inclusively, in an open-ended fashion, and do not exclude additional elements, features, acts, operations, blocks, and so forth. Also, the term “or” is used in its inclusive sense (and not in its exclusive sense) so that when used, for example, to connect a list of elements, the term “or” means one, some, or all of the elements in the list. In addition, the articles “a,” “an,” and “the” as used in this application and the appended claims are to be construed to mean “one or more” or “at least one” unless specified otherwise.

As used herein, a phrase referring to “at least one of” a list of items refers to any combination of those items, including single members. As an example, “at least one of: A, B, or C” is intended to cover: A; B; C; A and B; A and C; B and C; and A, B, and C. Conjunctive language such as the phrase “at least one of X, Y, and Z,” unless specifically stated otherwise, is otherwise understood with the context as used in general to convey that an item, term, etc. may be at least one of X, Y, or Z. Thus, such conjunctive language is not generally intended to imply that certain embodiments require at least one of X, at least one of Y, and at least one of Z to each be present.

The operations of the methods described herein may be carried out in any suitable order, or simultaneously where appropriate. Additionally, individual blocks may be deleted from, combined with other blocks, or rearranged in any of the methods without departing from the scope of the subject matter described herein. Aspects of any of the examples described above may be combined with aspects of any of the other examples described to form further examples without losing the effect sought.

It will be understood that the above description is given by way of example only and that various modifications may be made by those skilled in the art. The above specification, examples, and data provide a complete description of the structure and use of exemplary embodiments. Although various embodiments have been described above with a certain degree of particularity, or with reference to one or more individual embodiments, those skilled in the art could make numerous alterations to the disclosed embodiments without departing from the scope of this specification.

### APPENDIX: BIBLIOGRAPHY OF LITERATURE RELATING TO QUANTUM COMPUTING

[1] F. Arute, K. Arya, R. Babbush, D. Bacon, J. C. Bardin, R. Barends, R. Biswas, S. Boixo, F. G. Brandao, D. A. Buell, et al., Quantum supremacy using a programmable superconducting processor, Nature 574, 505 (2019).
[2] A. Peruzzo, J. McClean, P. Shadbolt, M.-H. Yung, X.-Q. Zhou, P. J. Love, A. Aspuru-Guzik, and J. L. O'brien, A variational eigenvalue solver on a photonic quantum processor, Nature communications 5, 1 (2014).
[3] B. F. Schi er, J. Tura, and J. I. Cirac, Adiabatic spectroscopy and a variational quantum adiabatic algorithm, arXiv preprint arXiv: 2103.01226 (2021).
[4] B. Bauer, D. Wecker, A. J. Millis, M. B. Hastings, and M. Troyer, Hybrid quantum-classical approach to correlated materials, Physical Review X 6, 031045 (2016).
[5] K. M. Nakanishi, K. Fujii, and S. Todo, Sequential minimal optimization for quantum-classical hybrid algorithms, Physical Review Research 2, 043158 (2020).
[6] S. McArdle, X. Yuan, and S. Benjamin, Error-mitigated digital quantum simulation, Physical review letters 122, 180501 (2019).
[7] M. Cerezo, A. Arrasmith, R. Babbush, S. C. Benjamin, S. Endo, K. Fujii, J. R. McClean, K. Mitarai, X. Yuan, L. Cincio, et al., Variational quantum algorithms, Nature Reviews Physics 3, 625 (2021).
[8] J. R. McClean, J. Romero, R. Babbush, and A. Aspuru-Guzik, The theory of variational hybrid quantumclassical algorithms, New Journal of Physics 18, 023023 (2016).
[9] J. R. McClean, S. Boixo, V. N. Smelyanskiy, R. Babbush, and H. Neven, Barren plateaus in quantum neural network training landscapes, Nature communications 9, 1 (2018).
[10] S. Wang, E. Fontana, M. Cerezo, K. Sharma, A. Sone, L. Cincio, and P. J. Coles, Noise-induced barren plateaus in variational quantum algorithms, Nature communications 12, 1 (2021).
[11] B. Schoellkopf, J. Platt, and T. Hofmann, Advances in Neural Information Processing Systems 19: Proceedings of the 2006 Conference, Vol. 19 (Mit Press, 2007).
[12] G. E. Hinton, S. Osindero, and Y.-W. Teh, A fast learning algorithm for deep belief nets, Neural computation 18, 1527 (2006).
[13] A. Skolik, J. R. McClean, M. Mohseni, P. van der Smagt, and M. Leib, Layerwise learning for quantum neural networks, Quantum Machine Intelligence 3, 1 (2021).
[14] T. Yanai and G. K.-L. Chan, Canonical transformation theory for multireference problems, The Journal of chemical physics 124, 194106 (2006).
[15] K. H. Marti, I. M. Ond k, G. Moritz, and M. Reiher, Density matrix renormalization group calculations on relative energies of transition metal complexes and clusters, The Journal of Chemical Physics 128, 014104 (2008), https://doi.org/10.1063/1.2805383.
[16] S.-J. Ran, Encoding of matrix product states into quantum circuits of one- and two-qubit gates, Physical Review A 101, 032310 (2020).
[17] C. Sch on, E. Solano, F. Verstraete, J. I. Cirac, and M. M. Wolf, Sequential generation of entangled multiqubit states, Physical review letters 95, 110503 (2005).
[18] A. M. Childs and N. Wiebe, Hamiltonian simulation using linear combinations of unitary operations, Quantum Information and Computation 12, 901-924 10.26421 QIC12.11-12 (2012).
[19] R. J. Bartlett and J. F. Stanton, Applications of posthartree|fock methods: A tutorial, Reviews in computational chemistry, 65 (1994).
[20] D. I. Lyakh, M. Musia 1, V. F. Lotrich, and R. J. Bartlett, Multireference nature of chemistry: The coupled-cluster view, Chemical reviews 112, 182 (2012).
[21] R. Olivares-Amaya, W. Hu, N. Nakatani, S. Sharma, J. Yang, and G. K.-L. Chan, The ab-initio density matrix renormalization group in practice, The Journal of chemical physics 142, 034102 (2015).
[22] C. J. Stein and M. Reiher, Automated selection of active orbital spaces, Journal of chemical theory and computation 12, 1760 (2016).
[23] C. J. Stein and M. Reiher, Automated identification of relevant frontier orbitals for chemical compounds and processes, CHIMIA International Journal for Chemistry 71, 170 (2017).
[24] C. J. Stein, V. von Burg, and M. Reiher, The delicate balance of static and dynamic electron correlation, Journal of Chemical Theory and Computation 12, 3764 (2016).
[25] C. J. Stein and M. Reiher, Measuring multiconfigurational character by orbital entanglement, Molecular Physics 115, 2110 (2017).
[26] F. A. Evangelista, Perspective: Multireference coupled cluster theories of dynamical electron correlation, The Journal of Chemical Physics 149, 030901 (2018).
[27] M. Ganahl, J. Beall, M. Hauru, A. G. M. Lewis, J. H. Yoo, Y. Zou, and G. Vidal, Density matrix renormalization group with tensor processing units (2022), arXiv: 2204.05693 [cond-mat.str-el].
[28] A. Baiardi and M. Reiher, The density matrix renormalization group in chemistry and molecular physics: Recent developments and new challenges, The Journal of Chemical Physics 152, 040903 (2020).
[29] W. Hu and G. K.-L. Chan, Excited-state geometry optimization with the density matrix renormalization group, as applied to polyenes, Journal of Chemical Theory and Computation 11, 3000 (2015), pMID: 26575737, https://doi.org/10.1021/acs.jetc.5b00174.
[30] T. Yanai and G. K.-L. Chan, Canonical transformation theory from extended normal ordering, The Journal of chemical physics 127, 104107 (2007).
[31] E. Neuscamman, T. Yanai, and G. K.-L. Chan Chan, A review of canonical transformation theory, International Reviews in Physical Chemistry 29, 231 (2010).
[32] T. Yanai and T. Shiozaki, Canonical transcorrelated theory with projected slater-type geminals, The Journal of chemical physics 136, 084107 (2012).
[33] T. Yanai, Y. Kurashige, E. Neuscamman, and G. K.-L. Chan, Extended implementation of canonical transformation theory: parallelization and a new level-shifted condition, Physical Chemistry Chemical Physics 14, 7809 (2012).
[34] K. Shamasundar, Cumulant decomposition of reduced density matrices, multireference normal ordering, and wicks theorem: A spin-free approach, The Journal of chemical physics 131, 174109 (2009).
[35] M. Hanauer and A. Kohn, Meaning and magnitude of the reduced density matrix cumulants, Chemical Physics 401, 50 (2012).
[36] N. Hatano and M. Suzuki, Finding exponential product formulas of higher orders, in Quantum annealing and other optimization methods (Springer, 2005) pp. 37 {68.
[37] H. R. Grimsley, D. Claudino, S. E. Economou, E. Barnes, and N. J. Mayhall, Is the trotterized uccsd ansatz chemically well-defined?, Journal of chemical theory and computation 16, 1 (2019).
[38] F. A. Evangelista, W. D. Allen, and H. F. Schaefer III, High-order excitations in state-universal and state-specific multireference coupled cluster theories: Model systems, The Journal of chemical physics 125, 154113 (2006).
[39] M. Hanrath, Higher excitations for an exponential multireference wavefunction ansatz and single-reference based multireference coupled cluster ansatz: Application to model systems h 4, p 4, and be h 2, The Journal of chemical physics 128, 154118 (2008).
[40] G. D. Purvis III, R. Shepard, F. B. Brown, and R. J. Bartlett, C2v insertion pathway for beh2: A test problem for the coupled-cluster single and double excitation model, International Journal of Quantum Chemistry 23, 835 (1983).
[41] K. Jankowski and J. Paldus, Applicability of coupled-pair theories to quasidegenerate electronic states: A model study, International Journal of Quantum Chemistry 18, 1243 (1980).
[42] Q. Sun, T. C. Berkelbach, N. S. Blunt, G. H. Booth, S. Guo, Z. Li, J. Liu, J. D. McClain, E. R. Sayfutyarova, S. Sharma, et al., Pyscf: the python-based simulations of chemistry framework, Wiley Interdisciplinary Reviews: Computational Molecular Science 8, e1340 (2018).
[43] S. Wouters, W. Poelmans, P. W. Ayers, and D. Van Neck, Chemps2: a free open-source spin-adapted implementation of the density matrix renormalization group for ab initio quantum chemistry, Computer Physics Communications 185, 1501 (2014).
[44] S. Wouters and D. Van Neck, The density matrix renormalization group for ab initio quantum chemistry, European Physical Journal D 68, 272 (2014).
[45] S. Wouters, T. Bogaerts, P. Van Der Voort, V. Van Speybroeck, and D. Van Neck, Communication: Dmrgscf study of the singlet, triplet, and quintet states of oxo-mn(salen), Journal of Chemical Physics 140, 241103 (2014).
[46] S. Wouters, V. Van Speybroeck, and D. Van Neck, Dmrgcaspt2 study of the longitudinal static second hyperpolarizability of all-trans polyenes, Journal of Chemical Physics 145, 054120 (2016).
[47] Inquanto-quantinuum, https://www.quantinuum.com/products/inquanto (2022).
[48] A. Cowtan, S. Dilkes, R. Duncan, W. Simmons, and S. Sivarajah, Phase gadget synthesis for shallow circuits, arXiv preprint arXiv: 1906.01734 (2019).
[49] S. Sivarajah, S. Dilkes, A. Cowtan, W. Simmons, A. Edgington, and R. Duncan, t|ket>: a retargetable compiler for NISQ devices, Quantum Science and Technology 6, 014003 (2020).
[50] C. G. Broyden, The convergence of a class of double-rank minimization algorithms 1. general considerations, IMA Journal of Applied Mathematics 6, 76 (1970).
[51] R. Fletcher, A new approach to variable metric algorithms, The computer journal 13, 317 (1970).
[52] D. Goldfarb, A family of variable-metric methods derived by variational means, Mathematics of computation 24, 23 (1970).
[53] D. F. Shanno, Conditioning of quasi-newton methods for function minimization, Mathematics of computation 24, 647 (1970).
[54] D. J. Thouless, Stability conditions and nuclear rotations in the hartree-fock theory, Nuclear Physics 21, 225 (1960).
[55] M.-C. Ba˜nuls, D. Perez-Garca, M. M. Wolf, F. Verstraete, and J. I. Cirac, Sequentially generated states for the study of two-dimensional systems, Physical Review A 77, 052306 (2008).
[56] D. Perez-Garcia, F. Verstraete, M. M. Wolf, and J. I. Cirac, Matrix product state representations, arXiv preprint quant-ph 0608197 (2006).
[57] V. V. Shende, S. S. Bullock, and I. L. Markov, Synthesis of quantum-logic circuits, IEEE Transactions on Computer-Aided Design of Integrated Circuits and Systems 25, 1000 (2006).
[58] R. Iten, R. Colbeck, I. Kukuljan, J. Home, and M. Christandl, Quantum circuits for isometries, Physical Review A 93, 032318 (2016).
[59] M. Z. Rahman and J. E. Rice, Templates for positive and negative control to oli networks, in International Conference on Reversible Computation (Springer, 2014) pp. 125-136.
[60] R. Babbush, C. Gidney, D. W. Berry, N. Wiebe, J. Mc-Clean, A. Paler, A. Fowler, and H. Neven, Encoding electronic spectra in quantum circuits with linear t complexity, Physical Review X 8, 041015 (2018).
[61] A. Ralli, P. J. Love, A. Tranter, and P. V. Coveney, Implementation of measurement reduction for the variational quantum eigensolver, Physical Review Research 3, 033195 (2021).
[62] A. Barenco, C. H. Bennett, R. Cleve, D. P. DiVincenzo, N. Margolus, P. Shor, T. Sleator, J. A. Smolin, and H. Weinfurter, Elementary gates for quantum computation, Physical review A 52, 3457 (1995).
[63] G.-L. Long and Y. Sun, Efficient scheme for initializing a quantum register with an arbitrary superposed state, Physical Review A 64, 014303 (2001).
[64] L. K. Grover, Quantum mechanics helps in searching for a needle in a haystack, Physical review letters 79, 325 (1997).
[65] D. W. Berry, A. M. Childs, R. Cleve, R. Kothari, and R. D. Somma, Exponential improvement in precision for simulating sparse hamiltonians, in Forum of Mathematics, Sigma, Vol. 5 (Cambridge University Press, 2017).
[66] G. G. Guerreschi, Repeat-until-success circuits with xed-point oblivious amplitude amplication, Physical Review A 99, 022306 (2019).
[67] J. Hauschild, E. Leviatan, J. H. Bardarson, E. Altman, M. P. Zaletel, and F. Pollmann, Finding purifications with minimal entanglement, Physical Review B 98, 235163 (2018).
[68] H. R. Grimsley, S. E. Economou, E. Barnes, and N. J. Mayhall, An adaptive variational algorithm for exact molecular simulations on a quantum computer, Nature communications 10, 1 (2019).
[69] B. T. Gard, L. Zhu, G. S. Barron, N. J. Mayhall, S. E. Economou, and E. Barnes, Efficient symmetry-preserving state preparation circuits for the variational quantum eigensolver algorithm, npj Quantum Information 6, 1 (2020).
[70] P.-F. Zhou, R. Hong, and S.-J. Ran, Automatically differentiable quantum circuit for many-qubit state preparation, Physical Review A 104, 042601 (2021).
[71] R. Haghshenas, J. Gray, A. C. Potter, and G. K.-L. Chan, Variational power of quantum circuit tensor networks, Physical Review X 12, 10.1103 physrevx. 12.011047 (2022).
[72] E. Cruz, F. Baccari, J. Tura, N. Schuch, and J. I. Cirac, Preparation and verification of tensor network states, Phys. Rev. Research 4, 023161 (2022).
[73] S. Lu, M. C. Ba˜n uls, and J. I. Cirac, Algorithms for quantum simulation at finite energies, PRX Quantum 2, 10.1103 prxquantum.2.020321 (2021).
[74] C. Angeli, R. Cimiraglia, S. Evangelisti, T. Leininger, and J.-P. Malrieu, Introduction of n-electron valence states for multireference perturbation theory, The Journal of Chemical Physics 114, 10252 (2001), https://doi.org/10.1063/1.1361246.
[75] K. Pernal, Electron correlation from the adiabatic connection for multireference wave functions, Phys. Rev. Lett. 120, 013001 (2018).

1. A method for configuring a hybrid computing arrangement to implement a simulation of a chemical system, wherein the hybrid computing arrangement includes a combination of a classical computer coupled to a quantum computer, wherein the hybrid computing arrangement is configured in use to receive input data and to generate corresponding processed output data from the input data, wherein the method includes:
(a) configuring the classical computer to receive information describing a chemical system in the input data;
(b) configuring the classical computer to process the information describing the chemical system using a pre-entangler to generate a fixed circuit describing static correlations of a wavefunction that describes the chemical system, and using a quantum ansatz to generate a variational quantum circuit describing dynamic correlations of the wavefunction;
(c) configuring the quantum computer to execute a quantum circuit corresponding to the fixed circuit and the variational circuit to generate quantum computations results; and
(d) configuring the classical computer to process the quantum computational results to generate the output data including information describing an electron orbital simulation of the chemical system.

2. The method of claim 1, wherein the method includes configuring the pre-entangler to function as a parameter-free pre-entangler.

3. The method of claim 1, wherein the method includes configuring the pre-entangler using a Matrix Product States (MPS) algorithm.

4. The method of claim 3, wherein the method includes generating Matrix Product States (MPS) based on a linear combination of unitaries describing the chemical system.

5. The method of claim 3, wherein the method includes configuring the hybrid computer arrangement to generate Matrix Product States (MPS) using a Density Matrix Renormalization Group (DMRG) algorithm, to capture a complete active space (CAS) for one or more non-linear transition metal complexes included in the chemical system.

6. The method of claim 3, wherein the method includes configuring the hybrid computer arrangement to generate Matrix Product States, MPS, by using an MPS algorithm based on a sequential generation with ancilla qubits.

7. The method of claim 1, wherein the method includes using the quantum circuit to find ground states of a Hamiltonian of the chemical system.

8. The method of claim 1, wherein the method includes configuring the variational circuit as a variational quantum eigensolver based on one or more Canonical Transformations, wherein the method includes configuring the hybrid computing arrangement to use the classical computer to generate a Density Matrix Renormalization Group (DMRG) algorithm to build static correlations in wavefunctions describing the chemical system, wherein the Density Matrix Renormalization Group (DMRG) algorithm is used to generate a corresponding fixed part of the quantum circuit.

9. The method of claim 1, wherein the method includes configuring the hybrid computing arrangement to implement the following operations:
(i) configure the classical computer to process the information describing the chemical system to assign molecular orbits to an active space based on the chemical system; wherein the orbits are susceptible to occupying core, virtual and active spaces;
(ii) configure the classical computer to approximate static correlations of a Hamiltonian of the chemical system by using a DMRG algorithm as the pre-entangler to generate a Matrix Product States (MPS) description |ψ₀ [symbol] of a ground state for a given bond dimension D;
(iii) generate a quantum circuit that prepares the MPS description |ψ₀ [symbol] on the quantum computer;
(iv) construct a variational quantum circuit to describe dynamic correlations by coupling orbitals in the core, active and virtual spaces; and
(v) from results of executing the quantum circuit, minimize ground state energies to generate the output results.

10. A hybrid computing arrangement configured to implement a simulation of a chemical system, wherein the hybrid computing arrangement includes a combination of a classical computer coupled to a quantum computer, wherein the hybrid computing arrangement is configured in use to receive input data and to generate corresponding processed output data from the input data, wherein the computing arrangement is:
(a) configured to receive information describing a chemical system in the input data;
(b) configured to process the information describing the chemical system using a pre-entangler to generate a fixed circuit describing static correlations of a wavefunction that describes the chemical system, and using a quantum ansatz to generate a variational circuit describing dynamic correlations of the wavefunction;
(c) configured to execute a quantum circuit corresponding to the fixed circuit and the variational circuit to generate quantum computations results; and
(d) configured to process the quantum computational results to generate the output data including information describing an electron orbital simulation of the chemical system.

11. The hybrid computing arrangement of claim 10, wherein the pre-entangler is configured to function as a parameter-free pre-entangler.

12. The hybrid computing arrangement of claim 10, wherein the pre-entangler is configured to use a Matrix Product States (MPS) algorithm.

13. The hybrid computing arrangement of claim 12, wherein the hybrid computer arrangement is configured to generate Matrix Product States (MPS) using a Density Matrix Renormalization Group (DMRG) algorithm, to capture a complete active space (CAS) for one or more non-linear transition metal complexes included in the chemical system.

14. The hybrid computing arrangement of claim 12, wherein the hybrid computer arrangement is configured to generate Matrix Product States, MPS, by using an MPS algorithm based on a sequential generation with ancilla qubits.

15. The hybrid computing arrangement of claim 10, wherein the hybrid computing arrangement is configured to use the quantum circuit to find ground states of the chemical system's Hamiltonian.

16. The hybrid computing arrangement of claim 10, wherein the hybrid computing arrangement is configured to include the quantum ansatz as a variational quantum eigensolver based on one or more Canonical Transformations, wherein the hybrid computing arrangement is configured to use the classical computer to generate a Density Matrix Renormalization Group (DMRG) algorithm to build static correlations in wavefunctions describing the chemical system, wherein the Density Matrix Renormalization Group (DMRG) algorithm is used generate the corresponding fixed part of the DMRG-QCT quantum circuit.

17. The hybrid computing arrangement of claim 10, wherein the hybrid computing arrangement is configured:
(i) to assign molecular orbits to an active space based on the chemical system; wherein the orbits are susceptible to occupying core, virtual and active spaces;
(ii) to approximate ground states of the Hamiltonian by using a DMRG algorithm as the pre-entangler to generate a Matrix Product States (MPS) description |ψ₀ [symbol] of a ground state for a given bond dimension D;
(iii) to find a quantum circuit that prepares the MPS description |ψ₀ [symbol] on the quantum computer;
(iv) to construct a variational quantum circuit to describe dynamic correlations by coupling active orbitals in the core and active spaces; and
(v) from results of executing the quantum circuit to minimize ground state energies to generate the output results.

18. A non-transitory computer-readable storage medium comprising specific computer-readable instructions executable on data processing hardware, wherein the specific computer-readable instructions, when executed using the data processing hardware, implement the method of claim 1.
